(19) United States
(12) Patent Application Publication
(10) Pub. No.: US 2001/0013046 A1
(43) Pub. Date: Aug. 9, 2001

(54) Method of creating data for printing and system of creating data for printing

(76) Inventors: Takeshi Katayama, Kanagawa (JP); Shigeki Kawakami, Kanagawa (JP)

Correspondence Address: SUGHRUE, MION, ZINN, MACPEAK & SEAS, PLLC, Suite 800, 2100 Pennsylvania Avenue, N.W., Washington, DC, 20037-3213, US

(21) Appl. No.: 09/775,626

(22) Filed: Feb. 5, 2001

(30) Foreign Application Priority Data
Feb. 4, 2000 (JP) 2000-28466

(51) Int. Cl. G06F 17/21

(52) U.S. Cl. 707/530; 707/527

(57) ABSTRACT

A method of creating printing data, which enables a page editing operation and a layout operation to be carried out even if all the parts are not provided, and a system for performing the same. When there exists any unreceived part, an image for editing with a BlankEPS format 118 is created and the page editing operation is performed by using the image for editing with a BlankEPS format 118 as an alternative part for the unreceived part. A ProbeEPS 124 is created for every page as dummy page data, on which the image for editing 118 is still used, on the basis of the result of the page editing operation. A layout operation is performed by using the ProbeEPS 124 as an alternative part for each of the real page data to be output. When the unreceived part (an image to be output 114) is received, the image for editing with a BlankEPS format 118 is replaced with the received image to be output 114.

### BACKGROUND OF THE INVENTION

1. Field of the Invention

The present invention relates to a method of creating data for printing and a system of creating data for printing. More precisely, the present invention relates to a method of creating data for printing and a system of creating data for printing, in which data for printing is created by performing a page editing operation with a computer.

2. Description of the Related Art

Conventionally, DTP (Desktop Publishing), in which editing and printing operations of documents are performed by using a personal computer or the like, has been widely used in the field of printing. Digitalization of plate making process progressed due to the diffusion of DTP. Accordingly, in recent years, a CTP (Computer to Plate), in which a press plate is directly output from printing data without using any intermediate materials such as a film, has been put into practice due to full-digitalization.

In CTP, bitmap data for plate-making (referred to as “face data to be printed”, hereinafter) are created through a parts creating operation, a page editing operation, and a layout operation which are performed on a personal computer, and a press plate is output from a CTP output device. More precisely, in the parts creating operation, character data and/or illustration data are created by using a word processing software or graphic software, and a manuscript such as a photographic film is scanned by a scanner to create image data. In the page editing operation, characters, illustrations, and images are positioned by using an editing software, thereby determining the page layout. In the layout operation, face design and plate dividing are operated by using layout software.

Moreover, because image data used for a press plate (referred to as an “image to be output”, hereinafter) is normally made of tens to hundreds of megabytes, when an image to be output with a large data amount is used in an editing operation by an editing software, the load on the editing computer is heavy and even a layout operation causes the throughput to deteriorate. Accordingly, the editing operation cannot be performed comfortably. Therefore, an OPI (Open Prepress Interface) has been widely introduced in the publishing industry. In OPI, low resolution image data (referred to as an “image for editing”, hereinafter) is created by thinning the image to be output, an editing operation is performed by using the image for editing, and the low resolution image data is replaced with a high resolution image when the editing operation is completed.

Generally, various types of printing data are delivered to a printing company (or section) from a designing company (or section), and at the printing company, press plates are created by performing each of the above-described operations using the received printing data. At this stage, since a part of the printing data, such as an image to be output or a manuscript for advertisement, for example, is received from an advertising company, such data may occasionally arrive later than the printing data from the designing company.

According to the plate making process, employed prior to the introduction of CTP, which uses intermediate materials such as films, parts can be attached to the intermediate material, so that the page editing operation and the layout operation can be carried on even if all the parts are not provided (i.e., even if there exists any unreceived part).

In CTP, however, since a press plate is output directly from a personal computer, parts cannot be attached later like the plate making method using intermediate materials. Therefore, the layout operation cannot be started until all the parts are provided.

Moreover, even if the OPI is introduced to the CTP to perform a page editing operation, an image for editing is created from an image to be output, so that positions for the unreceived parts cannot be determined. Thus, the page editing operation cannot be completed until all the parts are provided.

### SUMMARY OF THE INVENTION

The present invention is provided to solve the aforementioned problems. That is, an object of the present invention is to provide a method of creating printing data which enables a page editing operation and a layout operation to be carried out even if all the parts are not provided, and a system for performing the same.

In order to achieve the aforementioned object, a first aspect of the present invention is a method of creating data for printing when performing page editing operation on a computer, the method including the steps of: (a) determining if there is any part of the page, for which corresponding parts data has not been received by the time of the page editing operation, and if so, creating dummy parts data for the unreceived parts data; (b) creating dummy page data by inserting the dummy parts data for the unreceived parts data in a position on the page allocated for the unreceived parts data; and (c) replacing the dummy parts data when the unreceived parts data is received, with the received parts data, for creating page data for printing.

A second aspect of the present invention is a method of creating data for printing according to the first aspect, wherein creating dummy parts data in the step of determining includes providing first information with the dummy parts data, and the step of replacing the dummy parts data includes referring to the first information.

A third aspect of the present invention is a method of creating data for printing according to the second aspect, wherein the first information includes data indicating a folder and a file in which the page data for printing is expected to be stored.

A fourth aspect of the present invention is a method of creating data for printing according to the second aspect, wherein the parts data when received, also includes the first information.

A fifth aspect of the present invention is a method of creating data for printing according to the first aspect, further including the steps of: (a) performing a layout operation using dummy page data to create dummy plate face data; and (b) creating plate face data for printing by replacing the dummy page data in the dummy plate face data when page data is available from the step of replacing dummy parts data.

A sixth aspect of the present invention is a method of creating data for printing according to the fifth aspect, wherein the step of creating dummy page data, includes providing second information with the dummy page data, and the step of creating plate face data includes referring to the second information.

A seventh aspect of the present invention is a method of creating data for printing according to the sixth aspect, wherein the second information includes data indicating a file and a page number in which the dummy page data is stored.

An eighth aspect of the present invention is a method of creating data for printing according to the sixth aspect, wherein the page data for printing, also includes the second information.

A ninth aspect of the present invention is a method of creating data for printing according to the first aspect, further including the step of inputting an instruction to determine if there is any part of the page for which corresponding parts data has not been received.

A tenth aspect of the present invention is a method of creating data for printing according to the ninth aspect, further including the step of terminating processing if the instruction has not been inputted.

An eleventh aspect of the present invention is a system for creating printing data during page editing and layout, the system including a data processing arrangement having program logic, the program logic including: (a) a first logic portion, which creates dummy parts data for unreceived parts data of a page; (b) a second logic portion, which creates dummy page data by inserting the dummy parts data for the unreceived parts data in a position on the page allocated for the unreceived parts data; and (c) a third logic portion, which replaces the dummy parts data when the unreceived parts data is received, with the received parts data, for creating page data for printing.

A twelfth aspect of the present invention is a system for creating printing data during page editing and layout, the system including a data processing arrangement having program logic, the program logic including: (a) a logic portion, which creates dummy parts data having link information for unreceived parts data, with the link information linking the dummy parts data with a storage location in the data processing arrangement, and inserts the dummy parts data in a position on the page allocated for the unreceived parts data; and (b) another logic portion, which operates in background monitoring the storage location in the data processing arrangement, and when parts data is stored at the storage location, the another logic portion replaces the dummy parts data with the parts data in accordance with the link information.

### BRIEF DESCRIPTION OF THE DRAWINGS

FIG. 1 is a schematic block diagram of a CTP system according to an embodiment of the present invention.

FIGS. 2A and 2B are block diagrams illustrating a detailed configuration of the CTP system.

FIGS. 3A and 3B are block diagrams illustrating a functional configuration of the CTP system.

FIG. 4A is a diagram for explanation of PDF page data 110A (received page data 110) used in the CTP system.

FIG. 4B is a diagram for explanation of the structure of PDF page data 110B (page data 110 which has been converted for editing) used in the CTP system.

FIG. 5 is a diagram for explanation of the structure of an image for editing used in the CTP system.

FIG. 6 is a diagram for explanation of the structure of an image to be output used in the CTP system.

FIG. 7 is a diagram for explanation of the structure of a page PS (page data having a PS description) used in the CTP system.

FIG. 8 is a diagram for explanation of the structure of a page PDF used in the CTP system.

FIG. 9 is a diagram for explanation of the structure of a ProbeEPS used in the CTP system.

FIG. 10 is a diagram for explanation of the structure of a ThinFlatPS used in the CTP system.

FIG. 11 is a diagram for explanation of the structure of page data to be output (CheckReadyPDF and PrintReadyPDF) used in the CTP system.

FIG. 12 is a diagram for explanation of the illustrative structure of a database.

FIG. 13 is a diagram showing an example of received manuscript groups for a brochure, and of received data included in the received manuscript groups.

FIG. 14 is a diagram showing the illustrative structure of a database created in the case of FIG. 13.

FIG. 15 is a diagram showing an example of a general management screen.

FIG. 16 is a diagram showing an example of a manuscript delivery state management screen.

FIG. 17 is a diagram showing an example of a parts management screen.

FIG. 18 is a diagram showing an example of a page management screen.

FIG. 19 is a diagram showing an example of an image selection screen.

FIG. 20 is a diagram showing an example of a reading range determination screen.

FIG. 21 is a diagram showing an example of an ICP tool screen.

FIGS. 22A and 22B are flow diagrams of operations performed by an operator when the CTP system is utilized.

FIGS. 23A and 23B are flowcharts showing processes carried out automatically by the CTP system (an OPI daemon) when the received data is stored in a received manuscript folder.

FIG. 24 is a flowchart showing processes carried out by the CTP system (the OPI daemon) upon receiving a command to create an image for editing with a BlankEPS format from an operator.

FIG. 25 is a flowchart showing processes performed by the CTP system (the OPI filter) upon receiving a run command of Preflight from an operator.

FIGS. 26A and 26B are diagrams showing a concept of processes performed by the CTP system when there exists any unreceived part.

### DESCRIPTION OF THE PREFERRED EMBODIMENTS

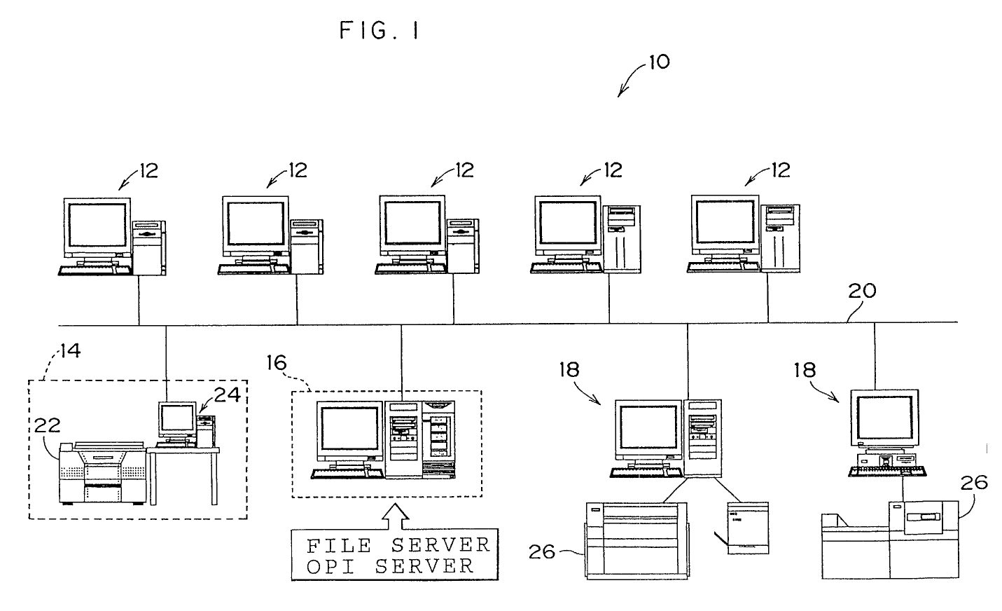

Referring to the drawings, one example of an embodiment relating to the present invention will be described in detail hereinafter. (Schematic Configuration of Overall System) FIG. 1 illustrates a schematic configuration of a CTP (Computer to Plate) system to which the present invention is applied. As shown in FIG. 1, a plurality of workstations 12, a scanner 14, a DTP (Desktop Publishing) server 16, and RIPs (Raster Image Processors) 18 are interconnected via a LAN (Local Area Network) 20, thereby forming a CTP system 10.

The workstations 12 are used for a page editing operation and a layout operation performed by operators.

The scanner 14 is configured with a scanning device 22 for plate making and a scanning computer 24 which controls operations of the scanning device 22, and can read images recorded on a manuscript, such as a positive film, with high resolution. The scanner 14 is used for a parts creating operation performed by operators.

The DTP server 16 manages various types of data (files) used to create press plates by the CTP system 10. The DTP server 16 also performs a replacing operation of images. That is, the DTP server 16 functions as a so-called file server and an OPI (Open Prepress Interface) server.

The RIP 18 is connected to a CTP output device 26, creates bitmap data for plate making, and outputs the bitmap data to the CTP output device 26. In the CTP output device 26, a press plate is created on the basis of the bitmap data for plate making received from the RIP 18 and is output.

The workstations 12, the DTP server 16, the RIPs 18, and the scanning computer 24 are configured respectively with storage devices, such as ROM, RAM, HDD (Hard Disk Drive) and the like, which store various types of programs and data (files), a CPU which runs various types of programs, and other devices although these devices are not shown.

(Detailed Configuration)

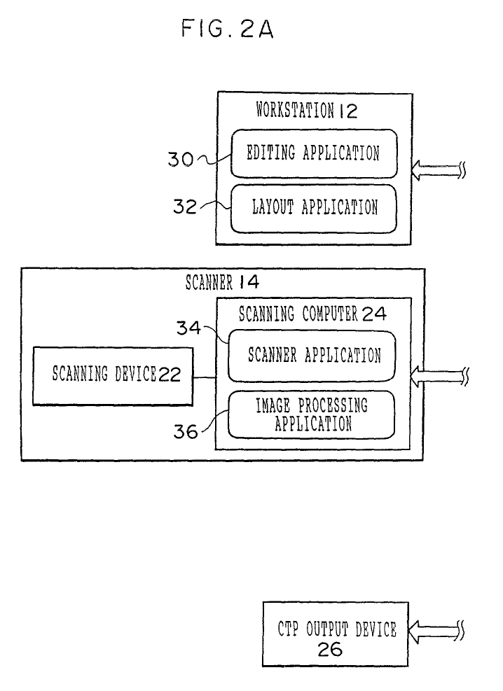

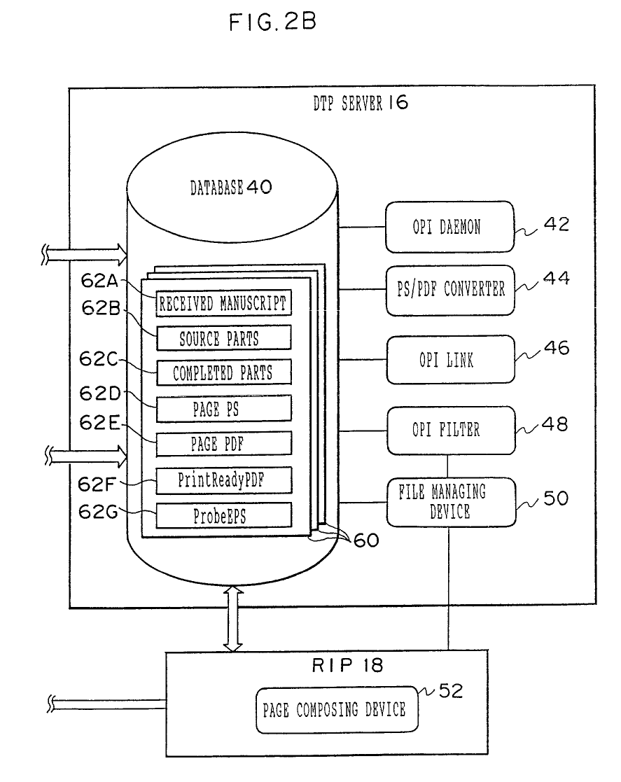

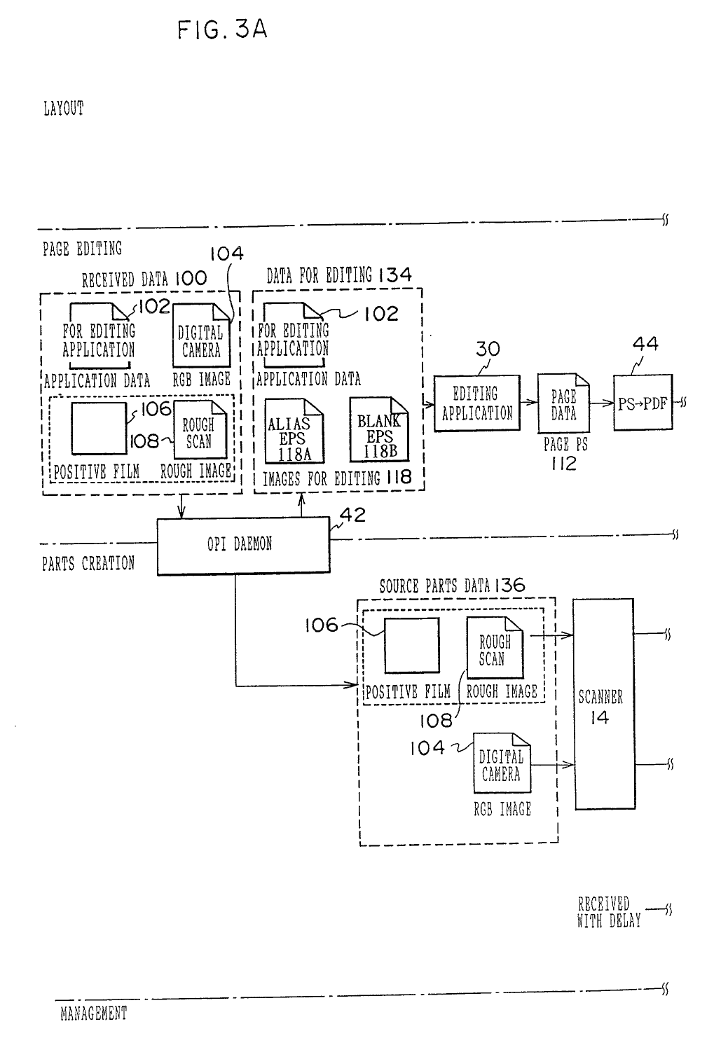

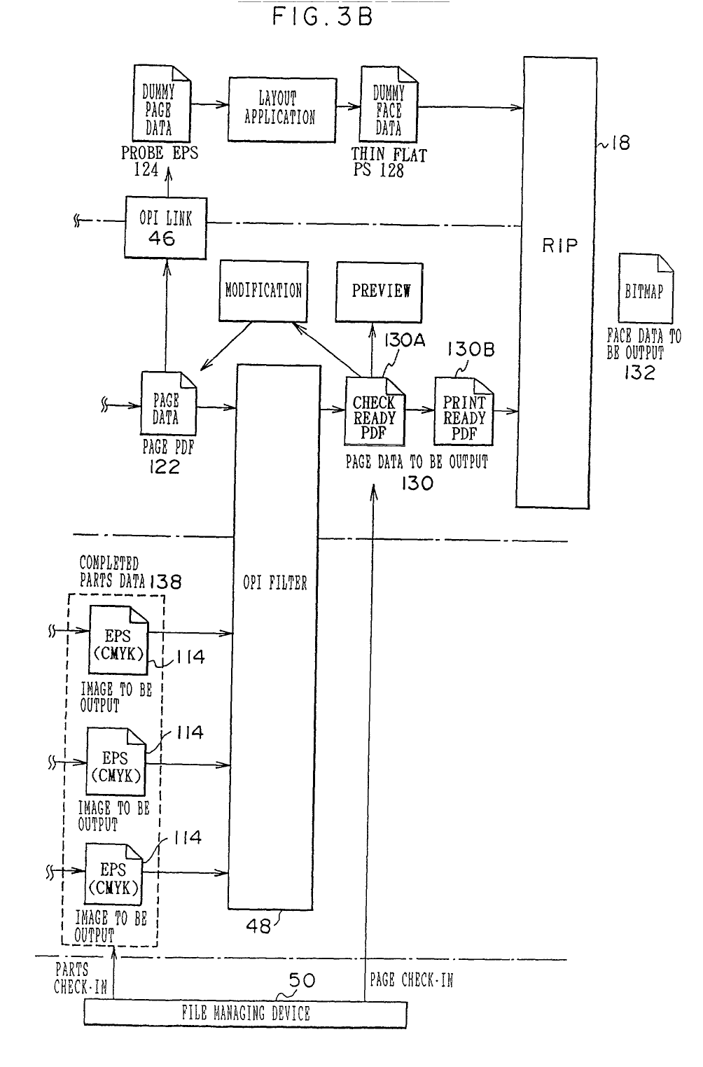

Referring to FIGS. 2A, 2B, 3A, and 3B, a detailed configuration of the CTP system 10 will be described hereinafter.

<Workstation>

In the workstation 12, an editing application software (referred to as an “editing application”, hereinafter) 30 is installed. An operator starts the editing application 30 on the workstation 12 and performs a page editing operation to determine the page layout.

In the workstation 12, a layout application software (referred to as a “layout application”, hereinafter) 32 is also installed. An operator starts the layout application 32 on the workstation 12 to perform layout operations such as face designing and plate dividing.

<Scanner>

A scanner application software (referred to as “scanner application”, hereinafter) 34 for reading images by means of the scanning device 22 is installed in the scanning computer 24. An operator starts the scanner application 34 on the scanning computer 24 to read images recorded on a manuscript such as a positive film 106 placed in the scanning device 22 with high resolution and to obtain images for plate making. The scanner application 34 also converts the obtained images for plate making into an EPS file (i.e., an image to be output 114 (described later) is created).

Generally, an image with CMYK color separations (referred to as a “CMYK image”, hereinafter) is used for plate making. Thus, the scanner 14 is also configured so as to create CMYK images.

A reading range (trimming range) of an image recorded on the positive film 106 is indicated by an operator. A GUI (Graphical User Interface) environment is provided in the scanning computer 24 for an operator to set the reading range (see “Illustrative Structure of Screen for Scanner” section described later).

Moreover, an image processing application software (referred to as an “image processing application”, hereinafter) 36 is installed in the scanning computer 24. An operator can perform various types of image processing (color conversion, retouch, illustration parts processing and the like) by starting the image processing application 36 on the scanning computer 24.

The image processing application 36 may be installed in the workstation 12 so that the image processing operation is performed on the workstation 12.

<DTP Server>

A database 40 is provided in the DTP server 16. The database 40 is accessible from the above-described workstations 12 and the scanner 14. The workstation 12 and the scanner 14 read out necessary data from the database 40, perform various types of processes, and then store the created data in the database 40 (an illustrative structure of the concrete database 40 will be described later).

That is, in the database 40, received data 100 which have been received from a designing company or the like, data which have been created through the page editing operation, the parts creating operation, and the layout operation performed by an operator, and the like are stored.

The received data 100 received from a designing company or the like will now be described. Generally, data (referred to as “application data”, hereinafter) 102 showing the result of page layout created after laying out parts such as images, texts, and graphics (illustrations) in a page by using an editing application, and parts data used for the page layout (i.e., data related to parts whose positions have been decided) are received from a designing company or the like. Parts data include, for example, data for an image with RGB color separations (referred to as an “RGB image”, hereinafter) 104, image data (referred to as a “rough image”, hereinafter since it is normally image data read with a rough resolution) 108, and the like. An RGB image 104 is obtained from a digital camera or the like. A rough image 108 is image data which is obtained by using a scanner to read the image recorded on a manuscript (a positive film 106 is considered as a representative of such a manuscript hereinafter) such as a positive film 106, and in which the position of the image, including trimming of the image, is determined. When a rough image 108 is received, a positive film 106 corresponding to the rough image is received together.

The application data 102 does not contain data of actual RGB image 104 nor rough image 108, but file names (or folder names and file names) of the RGB image 104 and the rough image 108 are attached thereto as link information. When the application data 102 is analyzed and the page layout is displayed on a display, the editing application 30 retrieves the RGB image 104 and the rough image 108 corresponding to the file names in the link information and allocates them at the positions on a page specified in the application data 102.

Therefore, when the application data 102 is delivered, the RGB image 104 and the rough image 108 are delivered by separate files. In the present embodiment, data (file) having a TIFF format or EPS format are assumed as the RGB image 104 and the rough image 108 which are delivered by separate files.

The data (file) having a XX format is referred to as a XX file, hereinafter (XX indicates the format name). For example, a file having image data of a TIFF format and of an EPS format are referred to as a TIFF file and an EPS file, respectively.

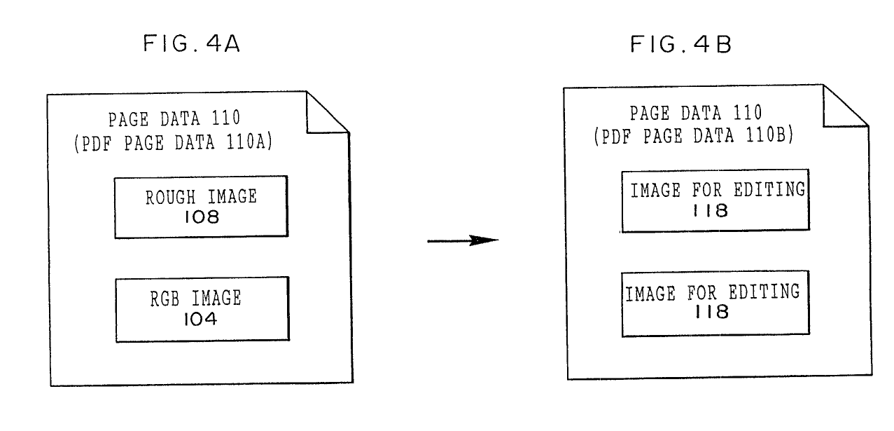

Occasionally, page data 110, in which the resulting layout image of an entire page including parts such as images, texts, and graphics (illustrations) are described in a PDL (Page Description Language), is received as received data 100 from a designing company or the like (see FIGS. 4A and 4B). That is, data for the RGB image 104 and the rough image 108 are embedded in the page data 110 (see FIG. 4A). A case in which a PDF (Portable Document Format) file is received as the page data 110 will be explained hereinafter as an example. The page data 110 for the PDF file is referred to as PDF page data 110. Naturally, PDL other than PDF (such as PS (PostScript)) may also be adaptable.

In the DTP server 16, an OPI system program for functioning the DTP server 16 as an OPI server is installed. By activating this program, the DTP server 16 enables an OPI daemon 42, a PS/PDF converter 44, an OPI link 46, an OPI filter 48, and a file managing device 50 to function and manages the database 40.

In the DTP server 16, the OPI daemon 42 is always active in the background as long as the OPI system program is active, and monitors a certain folder (a received manuscript folder 62A described later) in the database 40.

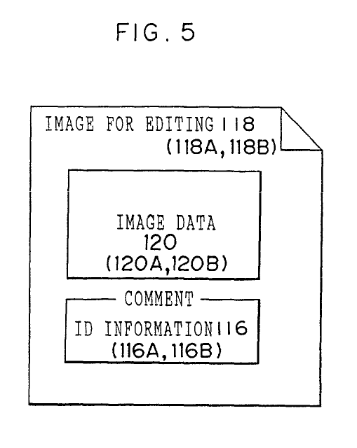

When received data 100 received from a designing company or the like is stored in a certain folder which is monitored, the OPI daemon 42 takes out an RGB image 104 and/or a rough image 108 from the received data 100, adds ID information 116A to the taken out data, and moves it to the different folder (i.e., from a received manuscript parts folder 62A to a source parts folder 62B described later) (see FIG. 5).

The ID information 116A may be any numbers, character strings, binary codes and the like which are managed uniquely by the system. In the present embodiment, names of folders and files to which the RGB image 104 and/or the rough image 108 are moved are used as the ID information 116A as an example.

Moreover, low resolution image data 120A is created by thinning the RGB image 104 and/or the rough image 108, and the ID information 116A added to the RGB image 104 and/or the rough image 108 is attached to (embedded in) the low resolution image data 120A as a comment utilized in a replacing operation (described later) by the OPI filter 48 to create an image for editing 118A which is turned out to be an EPS file (see FIG. 5). Such an EPS file is referred to as an “AliasEPS”, hereinafter.

The created image for editing 118A is divided into data for editing 134 which is used for page editing on the above-described workstation 12 and source parts data 136 which needs to be scanned by the scanner 14 in order to create an image to be output 114 by moving the image for editing 118A to a folder in which the image was existed before the source RGB image 104 and/or the rough image 108 are taken out.

When the editing image with an AliasEPS format 118A is created by taking off the RGB image 104 and/or the rough image 108 from the PDF page data 110, the editing image with an AliasEPS format 118A is embedded in the PDF page data 110 (see FIG. 4B) instead of taken-off RGB image 104 and/or the rough image 108. The PDF page data 110 from which the RGB image 104 and/or the rough image 108 are not taken off is referred to as PDF page data 110A, and the PDF page data 110 in which the image for editing 118 is embedded is referred to as PDF page data 110B, thereby distinguishing the two PDF page data.

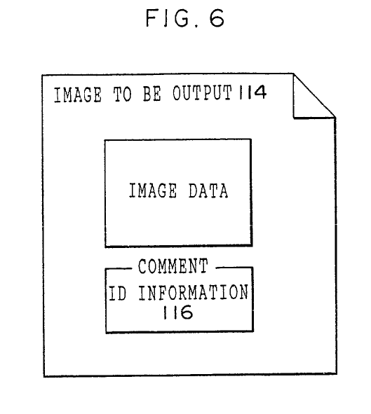

In the parts creating operation performed by the scanner 14, by referring to the rough image 108 which has been moved to another folder after the ID information 1 16A was added, an image to be output 114 is created by reading an image from the positive film 106 (rescanning) such that the image has the same image spacing (i.e., the same image structure) as that of the rough image 108. The ID information 116A which is the same as the one added to the rough image 108 is attached to the created image to be output 114 as a comment (see FIG. 6) for the replacing operation performed by the OPI filter 48 (described later).

Further, when the RGB image 104 and/or the rough image 108 do not exist, that is, even when there exists any unreceived part, the OPI daemon 42 can create an image for editing 118B for such an unreceived part by receiving an instruction to create an image for editing 118 from an operator.

To be more specific, low resolution image data 120B is created by thinning a preview screen which includes a term “unreceived” together with a title of the corresponding parts data, the expected date of delivery, and a manuscript delivering party, and which has an image size same as that of the corresponding parts data. Then ID information 116B for the image expected to be received is added as a comment to form an image for editing 118B with an EPS file format (see FIG. 5). Such an EPS file is referred to as a “BlankEPS”, hereinafter.

The ID information 116B may be any numbers, character strings, binary codes and the like which are managed uniquely by the system. In the present embodiment, names of folder and file to which the image to be output 114 is expected to be stored are used as the ID information 116B as an example. When the image for editing having an AliasEPS format 118A and the image for editing having a BlankEPS format 118B are not distinguished from one another, these are simply referred to as images for editing 118, hereinafter. The same idea is applied to the ID information 116 and to the image data 120.

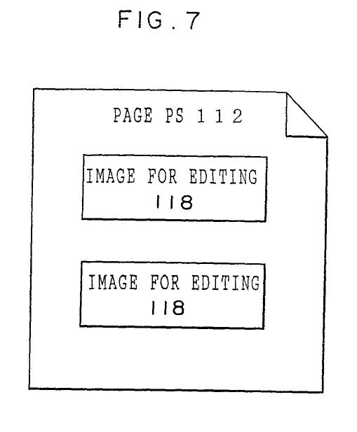

On the above-described workstation 12, a page editing operation is performed by using the image for editing 118. On the basis of the results (i.e., the application data 102 and/or the PDF page data 110 which have been edited), the workstation 12 creates and outputs edited page data (referred to as a “page PS”, hereinafter) 112, which describes the image of the entire page including parts such as images, texts, graphics (illustrations) and the like in PS (PostScript). Therefore, an image for editing 118 (described later) is embedded in the page PS 112 as the data for parts (images) allocated on the page (see FIG. 7). In a general editing application 30, a PS output mechanism is provided.

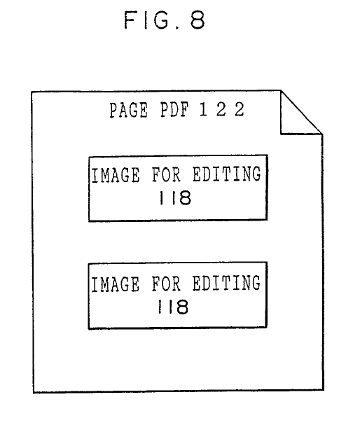

A PS/PDF converter 44 creates, automatically or under instructions from an operator, edited page data (referred to as a “page PDF”, hereinafter) 122 with a PDF description converted from the page PS 112 with a PS description created by the editing application 30. Therefore, an image for editing 118 is embedded also in the page PDF 122 as the data for parts (images) allocated on the page (see FIG. 8).

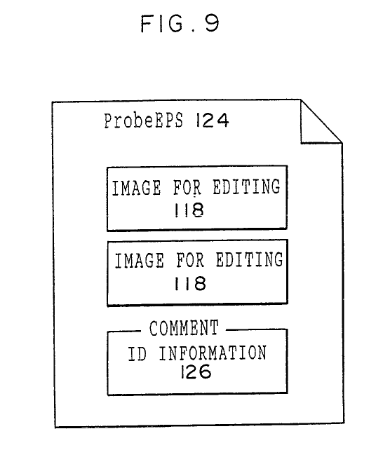

The OPI link 46 converts every page of the page PDF 122 to an EPS file and creates dummy page data (referred to as a “ProbeEPS”, hereinafter) 124 to which ID information 126 indicating the link information about the source page PDF 122 is attached as a comment. Therefore, an image for editing 118 is embedded also in the ProbeEPS 124 as the data for parts (images) allocated on the page (see FIG. 9). That is, it can be referred to as dummy page data because no image to be output 114 is used therein.

The ID information 126 may be any numbers, character strings, binary codes and the like which are managed uniquely by the system. In the present embodiment, the file name and the page number of the source page PDF 122 are used as the ID information 126 as an example. When the page PDF 122 is page data consisted of a single page, the page number may be omitted so that only the file name thereof is used as the ID information 126.

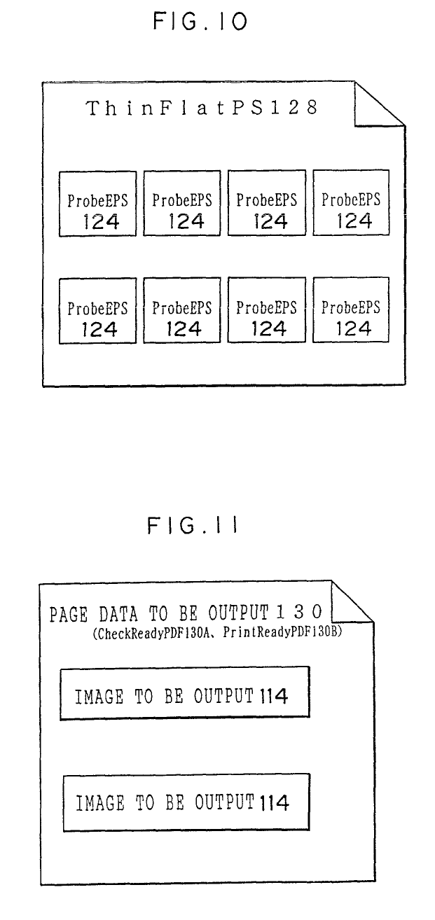

On the workstation 12, a layout operation is performed by using the ProbeEPS 124. On the basis of the results, the workstation 12 creates dummy face data (referred to as a “ThinFlatPS”, hereinafter) 128 which describes the image of the entire press plate face in PS. Therefore, ProbeEPSes 124 are embedded in the ThinFlatPS128 as an image of each page (see FIG. 10). That is, it can be referred to as dummy face data because ProbeEPSes 124, which are dummy page data, are used therein.

In a general layout application, EPS input and PS output functions, which are necessary for the layout application 32, are provided. Moreover, since characteristics information is described in DSC in the ProbeEPS 124, it may be possible for the layout application to utilize the characteristics information.

The OPI filter 48 replaces the images for editing 118 in the page PDF 122 with the images to be output 114 by referring to the ID information 116, and creates page data to be output 130 with a PDF file format containing the images to be output 114. Therefore, images to be output 114 are embedded in the page data to be output 130 as the data for parts (images) allocated on the page (see FIG. 11). Replacing operation of the image for editing 118 with the image to be output 114 by means of the OPI filter 48, that is, a creating operation of the page data to be output 130 is referred to as a “Preflight”, hereinafter.

The file managing device 50 manages information about various types of data managed in the database 40. For example, the file managing device 50 creates new folders and/or new data in the database 40 or deletes folders and/or data under instructions from an operator. Also, the file managing device 50 checks whether data having the same file name exists in the received data 100 or not. When there exists such data, the file managing device 50 informs the operator of the state and requests to change the file name.

The file managing device 50 also manages information indicating whether access to the image to be output 114 from the OPI filter 48 is permitted or not and whether the page data to be output 130 is permitted to be output (transmitted) to the RIP 18 or not (referred to as “Check-in information”, hereinafter). The Check-in information (permitted/not permitted) is switched under instructions from an operator. The instructing operation to switch the Check-in information to “permitted” is referred to as “Check-in”, hereinafter.

The page data to be output 130 which can be output to the RIP 18 is referred to as a CheckReadyPDF 130A, and the page data to be output 130 for which the Check-in operation is completed is referred to as a PrintReadyPDF 130B to distinguish the two page data to be output 130.

The file managing device 50 provides information about various types of data managed in the database 40 to an operator. The operator grasps the progress of operations from the information and carries out the management work.

Naturally, the management work is carried out by an operator using the workstation 12 such that the operator enters instructions to the file managing device 50 from the workstation 12 and receives information from the file managing device 50 through the workstation 12 since the DTP server 16 and the workstation 12 are interconnected. For these operations, a GUI environment is provided for operators by the file managing device 50 (see “Illustrative Structure of Management Screen” section described later).

<RIP>

The RIP 18 is provided with a page composing device 52. In the RIP 18, the ThinFlatPS 128 and the page data to be output 130 are developed into raster images (so-called rasterization) and bitmap data is created.

In the page composing device 52, the bitmap data created from the ThinFlatPS 128 and the one from the page data to be output 130 are composed so as to create fade data to be output 132 (bitmap data). The RIP 18 transmits the created fade data to be output 132 to the CTP output device 26. At the CTP output device 26, a press plate is created on the basis of the fade data to be output 132.

(Illustrative Structure of Database)

The CTP system 10 manages various data used to create a press plate as the database 40. In accordance with the present embodiment, a predetermined certain directory of a storage device (not shown), in which the DTP server 16 is provided, is used as the database 40. An illustrative structure of the database 40 will now be described.

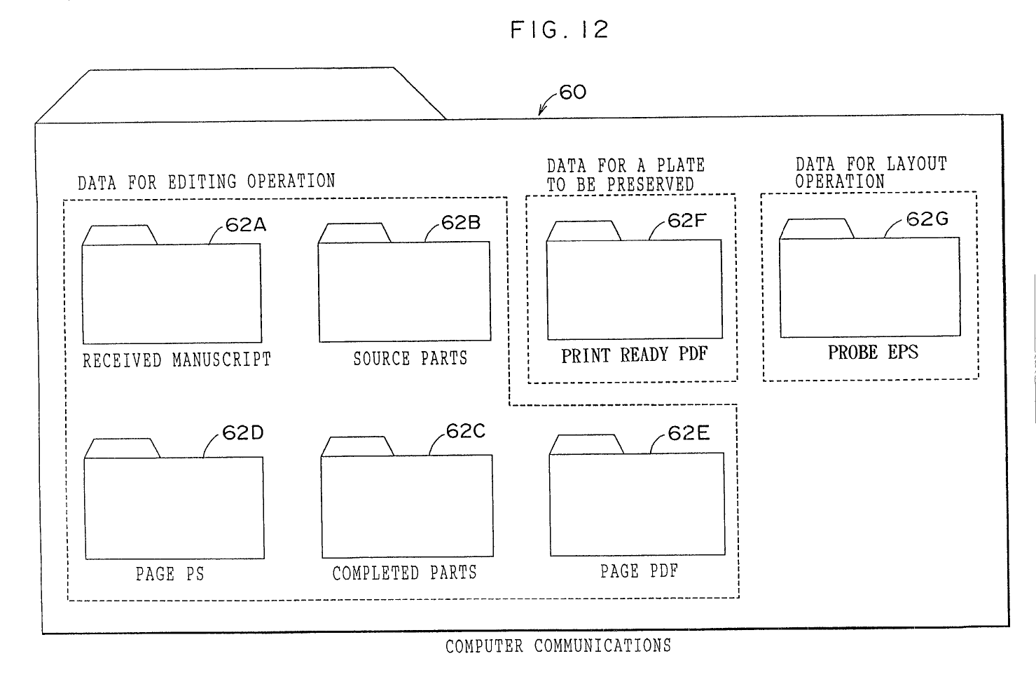

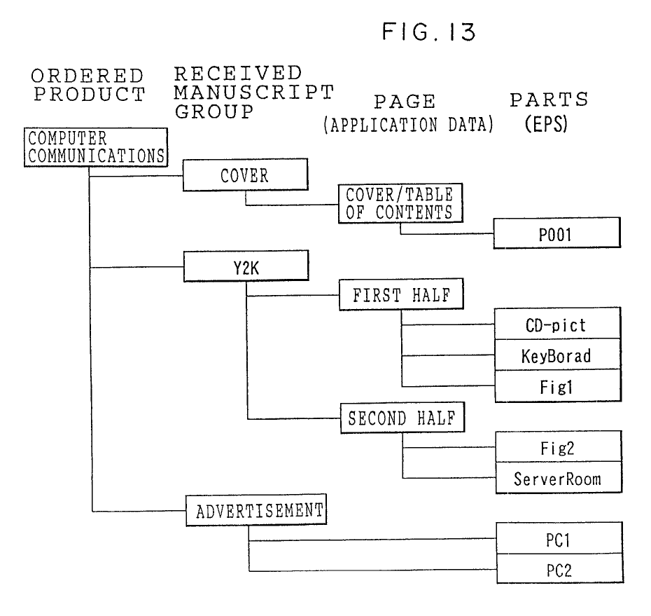

As shown in FIG. 2B, in the database 40, a folder (referred to as a “brochure folder”, hereinafter) 60 is provided for every brochure (product) created by the CTP system 10. In the brochure folder 60 (i.e., in the lower directories in the hierarchy), a received manuscript folder 62A, a source parts folder 62B, a completed parts folder 62C, a page PS folder 62D, a page PDF folder 62E, a PrintReadyPDF folder 62F, and a ProbeEPS folder 62G are provided in order to classify and store the data according to types thereof. In FIG. 12, a case in which a brochure folder 60 is provided for creating a brochure named “Computer Communications” is illustrated as an example.

When the received manuscript folder 62A, the source parts folder 62B, the completed parts folder 62C, the page PS folder 62D, the page PDF folder 62E, the PrintReadyPDF folder 62F, and the ProbeEPS folder 62G are not distinguished in description, these folders are simply referred to as data folders 62 hereinafter.

Occasionally, contents of a single brochure may be divided into several groups (referred to as “received manuscript groups”, hereinafter) such as a cover, a serial story column, a feature article and the like, and different designing companies may be in charge of page design of each group. Accordingly, data may be received from a plurality of designing companies. In such a case, group folders 64 corresponding to the respective received manuscript groups are further provided in each of the data folders 62 (i.e., in the lower directories in the hierarchy).

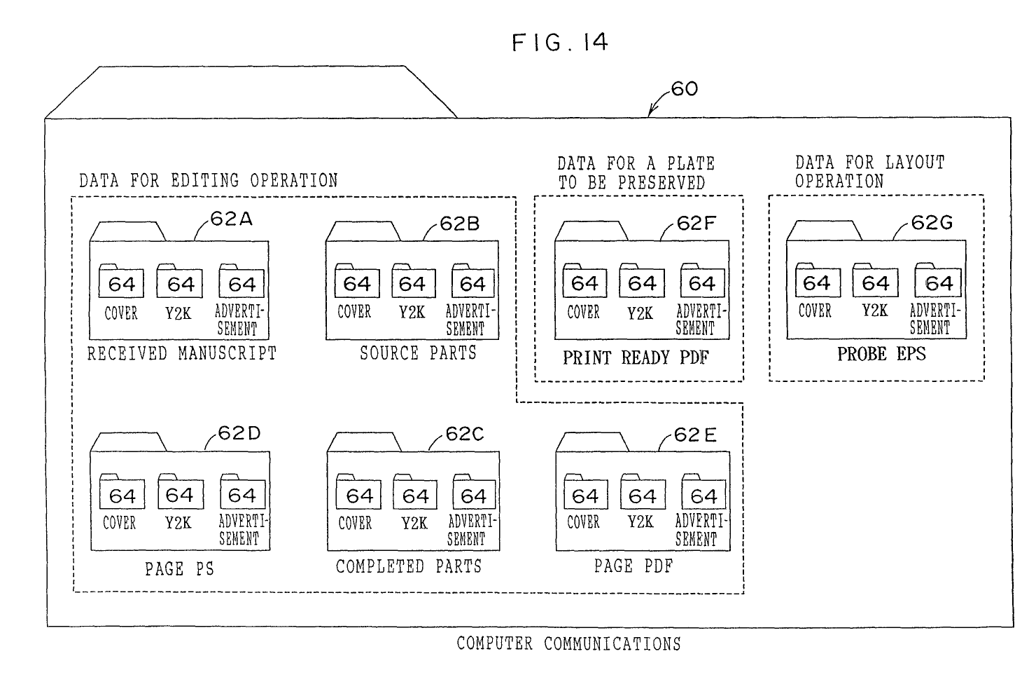

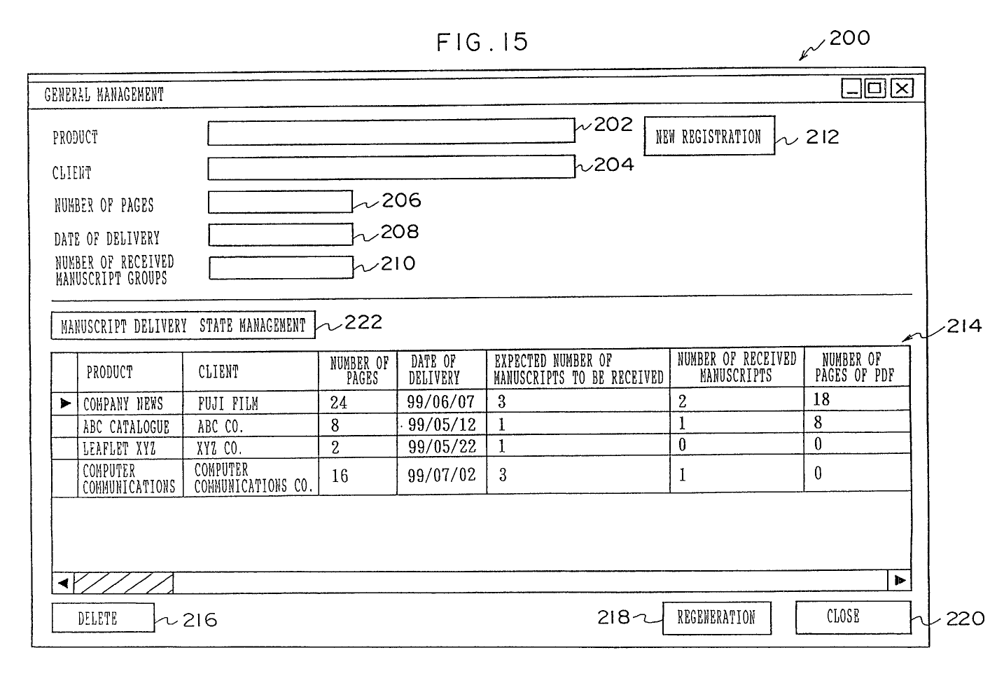

For example, as shown in FIG. 13, if the data for the brochure “Computer Communications” are divided into three received manuscript groups (i.e., “cover”, “Y2K”, and “advertisement”) and received respectively, three group folders 64 (“cover”, “Y2K”, and “advertisement”) are provided in (i.e., in the lower directories in the hierarchy of) each of the received manuscript folder 62A, the source parts folder 62B, the completed parts folder 62C, the page PS folder 62D, the page PDF folder 62E, the PrintReadyPDF folder 62F, and the ProbeEPS folder 62G (see FIG. 14).

Data for editing are stored in the received manuscript folder 62A, the source parts folder 62B, the completed parts folder 62C, the page PS folder 62D, and the page PDF folder 62E. In the PrintReadyPDF folder 62F, data for a plate to be preserved are stored. In the ProbeEPS folder 62G, data for a layout operation are stored.

The data stored in each data folder 62 will be described more specifically hereinafter. In the received manuscript folder 62A, the received data 100 which have been received from a designing company or the like are stored. To be more specific, application data 102, RGB images 104, rough images 108, and PDF page data 110A are stored. Moreover, after the OPI daemon 42 has operated therein, application data 102, PDF page data 110B, and images for editing 118 are stored in the received manuscript folder 62A. The data stored in the received manuscript folder 62A after the OPI daemon 42 has operated therein are referred to as data for editing 134 altogether.

In the source parts folder 62B, the RGB image 104 and/or the rough image 108 which are the source of the image for editing having an AliasEPS format 1 18A are stored. The image for editing having a BlankEPS format 118B is also stored therein. That is, the OPI daemon 42 creates and stores the image for editing with a BlankEPS format 118B in both of the received manuscript folder 62A and the source parts folder 62B. The data stored in the source parts folder 62B are referred to as source parts data 136 altogether.

In the completed parts folder 62C, the images to be output 114 created by the scanner 14 and the like are stored.

In the page PS folder 62D, the page PSes 112 created by the editing application 30 are stored.

In the page PDF folder 62E, the page PDFs 122 created by converting the page PSes 112 to PDF files by using the PS/PDF converter 44 are stored.

In the PrintReadyPDF folder 62F, the page data to be output 130 (CheckReadyPDFs 130A and PrintReadyPDFs 130B) which are created by the execution of Preflight, that is, by the replacing operation preformed by the OPI filter 48, are stored.

In the ProbeEPS folder 62G, the ProbeEPS 124 created by the OPI link 46 and the ThinFlatPS 128 created by performing the layout operation by using the ProbeEPS 124 are stored.

(Illustrative Structure of Management Screen)

Various types of screens which are displayed on the display of the workstation 12 to be used by an operator to enter instructions to the file managing device 50, to check information from the file managing device 50, and the like, will now be described. These screens are provided on the workstation 12 by the file managing device 50.

<General Management Screen>

In FIG. 15, an example of a general management screen 200 which is displayed for registering a brochure whose press plate is to be created by the CTP system 10 is shown. An operator manages all the brochures whose press plates are created by the CTP system 10 by the general management screen 200.

On the upper part of the general management screen 200, a product entering column 202, a client entering column 204, a number of pages entering column 206, a date of delivery entering column 208, a number of received manuscript groups entering column 210, and a new registration button 212 are provided.

Upon receipt of order for creating a brochure (product), an operator first invokes the general management screen (to be displayed), enters the brochure name in the product entering column 202, the client name (customer's name) in the client entering column 204, the total number of pages of the brochure in the number of pages entering column 206, the date of delivery (year, month, and day) of the brochure to the client in the date of delivery entering column 208, and the number of design companies and the like which deliver data for the brochure in the number of received manuscript groups entering column 210, and then clicks the new registration button 212 to register the brochure.

Responding to the registration of the brochure, the file managing device 50 creates a brochure folder 60 corresponding to this brochure in the database 40. The name of the brochure folder 60 will be the same as that of the brochure entered in the product entering column 202. The file managing device 50 also creates data folders 62 in the created brochure folder 60.

An information display section 214 is provided under the number of received manuscript groups entering column 210. In the information display section 214, information such as the product name, the client name, the number of pages, the date of delivery, the expected number of the received manuscripts (the number of received manuscript groups), the number of received manuscripts (the number of received manuscript groups which have already delivered the data), the number of pages of PDF (the number of pages of PrintReadyPDF 130B which have already been created) and the like is displayed for every brochure currently registered.

An operator can grasp the progress of operations for every brochure from the information displayed in the information display section 214.

Moreover, a delete button 216, a regeneration button 218, and a close button 220 are provided under the information display section 214. An operator can cancel the registration of a brochure (i.e., delete the corresponding brochure folder 60 from the database 40), update the displayed information in the information display section 214 to the latest information, and terminate the display of the general management screen 200 display (so-called “to close the screen”) by clicking the respective buttons if necessary.

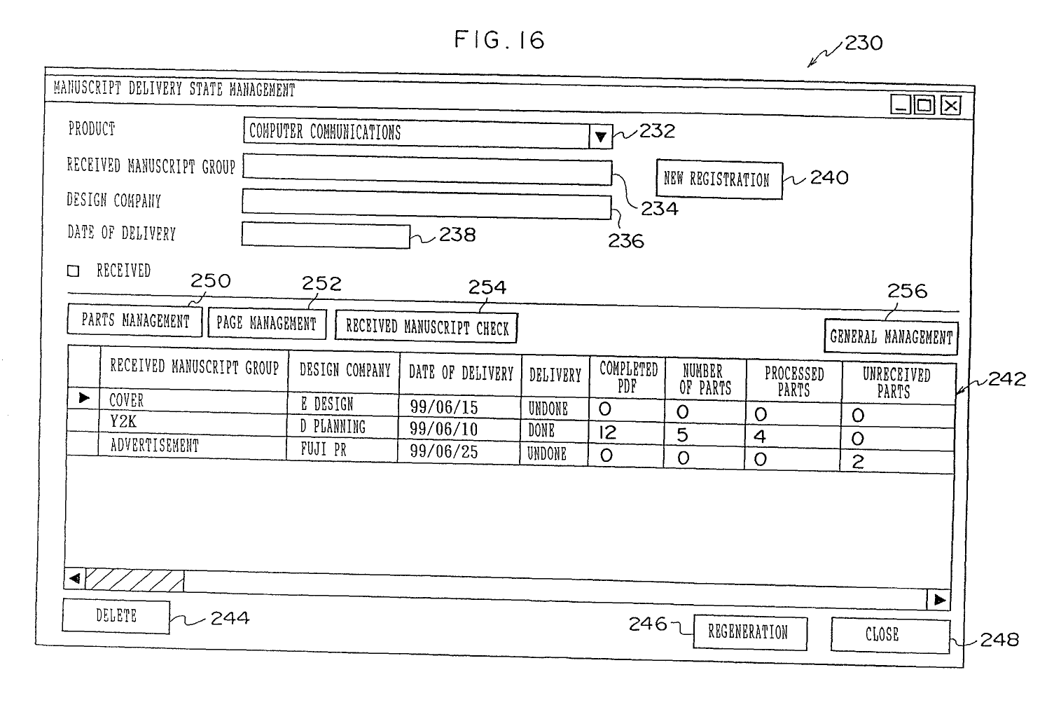

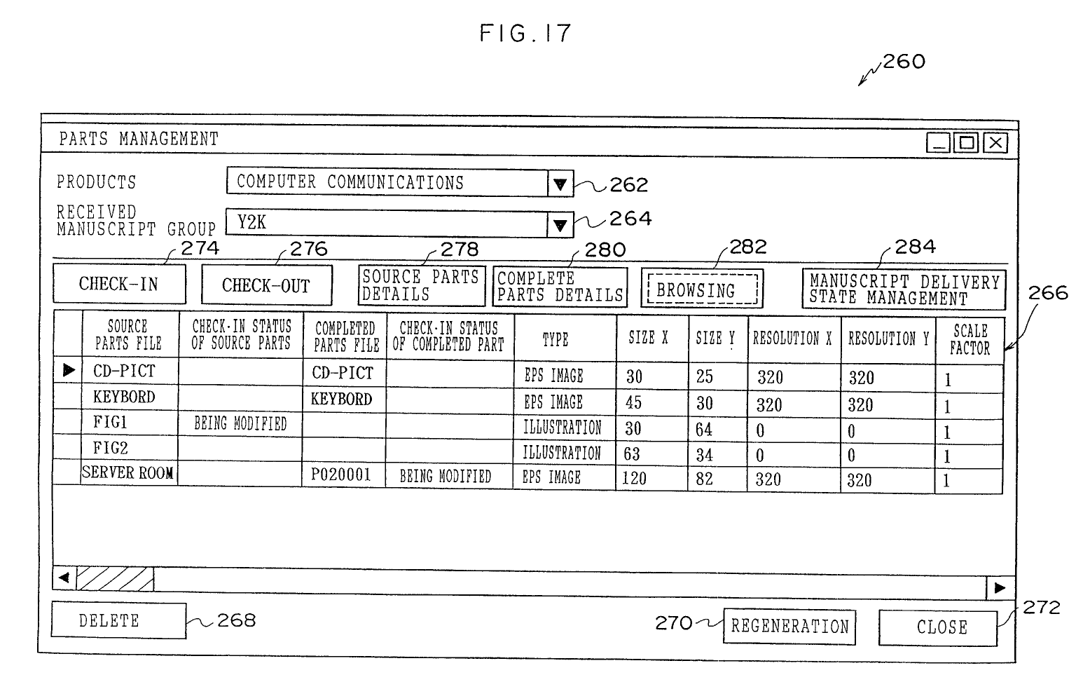

Further, a manuscript delivery state management button 222 is provided between the number of received manuscript groups entering column 210 and the information display section 214. When the manuscript delivery state management button 222 is clicked, the file managing device 50 displays a manuscript delivery state management screen 230, which is used to register a received manuscript group and to manage the delivery state of the data from designing companies and the like, on the display of the workstation 12 (see FIG. 16).

<Manuscript Delivery State Management Screen>

In FIG. 16, an example of the manuscript delivery state management screen 230 is shown. On the upper part of the manuscript delivery state management screen 230, a product selecting column 232, a received manuscript group entering column 234, a designing company entering column 236, a date of delivery entering column 238, and a new registration button 240 are provided.

The product selecting column 232 is formed as a pull-down menu, so that an operator can select a desirable brochure from the brochures (products) which have been registered through the general management screen 200. The brochure which has been selected on the general management screen 200 when the manuscript delivery state management button 222 was clicked on the general management screen 200, is selected immediately after the manuscript delivery state management screen 230 is displayed (as a default setting).

Moreover, an operator can register a received manuscript group of the brochure which has been selected in the product selecting column 232 by entering the name of the received manuscript group in the received manuscript group entering column 234, the name of the designing company in charge of design for the group in the designing company entering column 236, and the date of delivery (year, month, and day) of the data of the received manuscript group from the designing company in the date of delivery entering column 238, by handling a keyboard, a mouse or the like and then by clicking the new registration button 240.

Responding to the registration of the received manuscript group, the file managing device 50 creates a group folder 64 corresponding to this received manuscript group in each of the data folders 62 in the corresponding brochure folder 60. The name of the received manuscript group folder 64 will be the same as that of the received manuscript group entered in the received manuscript group entering column 234.

An information display section 242 is provided under the date of delivery entering column 238. In the information display section 242, information, for the brochure being selected in the product selecting column 232, such as the name of the received manuscript group, the name of the designing company, the date of delivery, the state of delivery (done/undone), amount of completed PDF (the number of pages for which the PrintReadyPDFs 130B have been created), the number of parts (the number of items such as images and illustrations used in the received manuscript group, i.e., the number of images to be output 114 needed for the received manuscript group), the number of parts already processed (the number of images to be output 114 which have been created), the number of unreceived parts (the number of parts, such as images for advertisement, whose data have not been received), and the like is displayed for every received manuscript group currently registered. An operator can grasp the progress of operations for every received manuscript group from the information displayed in the information display section 242.

Moreover, a delete button 244, a regeneration button 246, and a close button 248 are provided under the information display section 242. An operator can cancel the registration of a received manuscript group (i.e., delete the corresponding group folders 64 from the database 40), update the displayed information in the information display section 242 to the latest information, and close the manuscript delivery state management screen 230 by clicking the respective buttons if necessary.

Further, a parts management button 250, a page management button 252, a received manuscript check button 254, and a general management button 256 are provided between the date of delivery entering column 238 and the information display section 242.

When the parts management button 250 is clicked, the file managing device 50 displays, on the display of the workstation 12, a parts management screen 260 (described later (see FIG. 17)) which is used to manage the creation status of the images to be output.

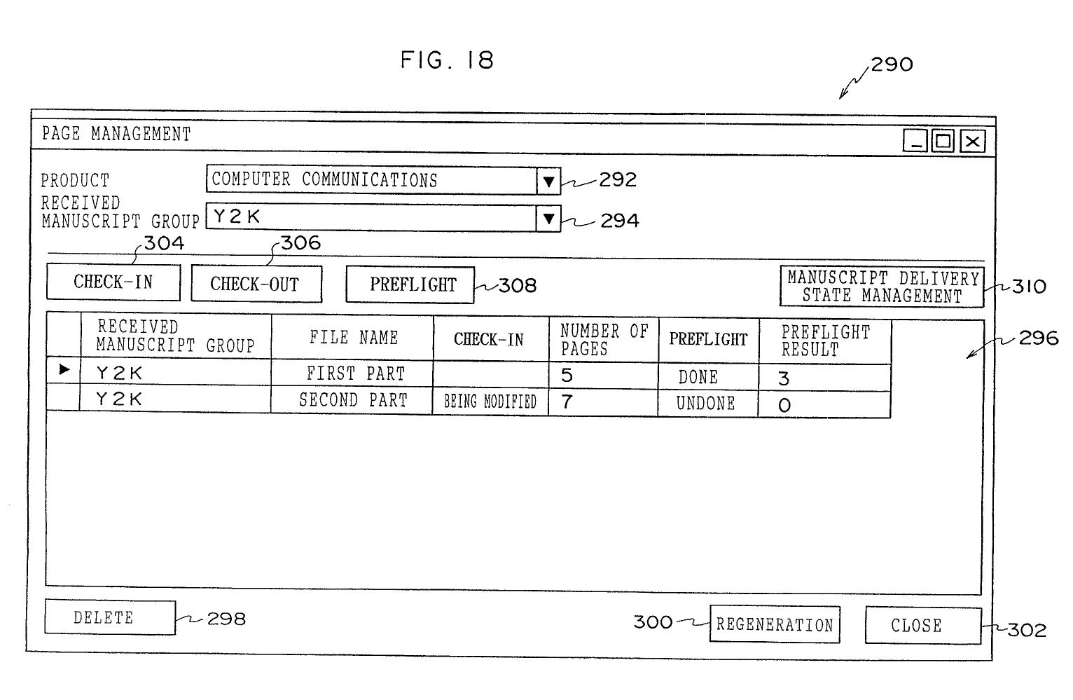

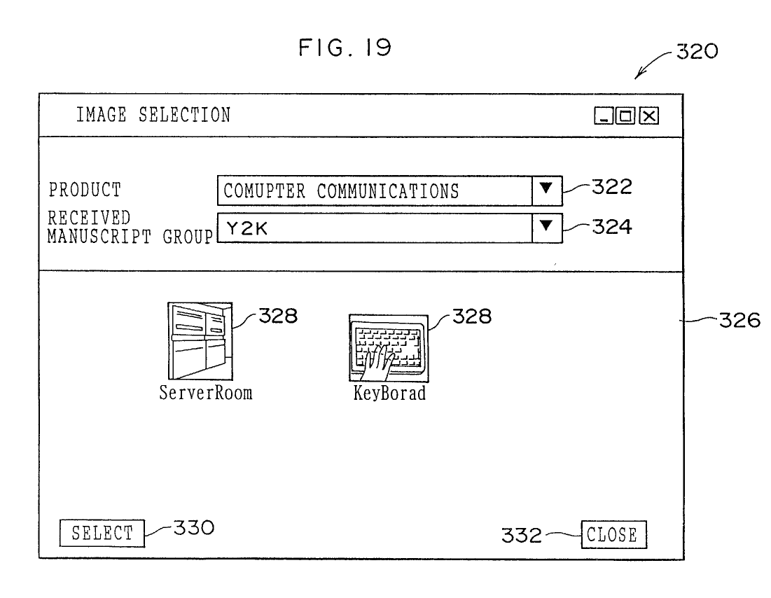

When the page management button 252 is clicked, the file managing device 50 displays, on the display of the workstation 12, a page management screen 290 (described later (see FIG. 18)) which is used to manage the creation status of the PrintReadyPDF 130B.

When the received manuscript check button 254 is clicked, the file managing device 50 checks whether data having the same file name exist in the received data. If there exist such data that have the same file name, the file managing device 50 displays a message informing an operator of the duplication on the display of the workstation 12 to prompt the operator to change the file name.

When the general management button 256 is clicked, the file managing device 50 displays the above-described general management screen 200 on the display of the workstation 12.

<Parts Management Screen>

In FIG. 17, an example of the parts management screen 260 is shown. On the upper part of the parts management screen 260, a product selecting column 262, and a received manuscript group selecting column 264 are provided.

Each of the product selecting column 262 and the received manuscript group selecting column 264 is formed as a pull-down menu, so that an operator can select a desirable brochure from the brochures (products) which have been registered through the general management screen 200, and then select a desirable received manuscript group from the received manuscript groups which have been registered for the brochure selected on the manuscript delivery state management screen 230. The brochure and the received manuscript group which have been selected on the manuscript delivery state management screen 230 when the parts management button 250 was clicked on the manuscript delivery state management screen 230, are selected immediately after the parts management screen 260 is displayed.

An information display section 266 is provided under the received manuscript group selecting column 264. In the information display section 266, information, for the received manuscript group selected in the product selecting column 262 and the received manuscript group selecting column 264, such as a source parts file (i.e., the file name of the corresponding rough image 108 and/or the RGB image 104 in the source parts folder 62B, and this column is left blank if the file is unreceived), a Check-in status of the source part (i.e., whether the source parts data is in the middle of modification or not, and “being modified” is displayed during modification), a completed parts file (i.e., the file name of the corresponding image to be output 114 in the completed parts folder 62C, and this column is left blank if such an image to be output 114 does not exist), a Check-in status of the completed part (i.e., whether the completed parts data is in the middle of modification or not), a classification (EPS image/illustration), size X and size Y (size of the image (mm)), the resolution (scanning resolution (mm/line, or dpi) of the scanner 14), and the like is displayed for every part. An operator can grasp the progress of parts creating operations for every part from the information displayed in the information display section 266.

Moreover, a delete button 268, a regeneration button 270, and a close button 272 are provided under the information display section 266. An operator can delete a part (i.e., delete a file corresponding to the part from the database 40), update the displayed information in the information display section 266 to the latest information, and close the parts management screen 260 by clicking the respective buttons if necessary.

Further, a Check-in button 274, a Check-out button 276, a source part details button 278, a completed part details button 280, a browsing button 282, and a manuscript delivery state management button 284 are provided between the received manuscript group selecting column 264 and the information display section 266.

When the Check-in button 274 is clicked (i.e., a Check-in operation of a part is requested by an operator), the file managing device 50 modifies the Check-in information for each part belonging to the received manuscript group selected in the product selecting column 262 and the received manuscript group selecting column 264 to “permitted”. This Check-in operation of a part requested by an operator is carried out when all of the images to be output 114 are confirmed to be ready.

When the Check-out button 276 is clicked, the file managing device 50 modifies the Check-in information for each part belonging to the received manuscript group selected in the product selecting column 262 and the received manuscript group selecting column 264 to “not permitted”.

When the source part details button 278 is clicked, the file managing device 50 displays detailed information about the source part (the RGB image 104 or the rough image 108) of the part selected in the information display section 266 on the display of the workstation 12. When the completed part details button 280 is clicked, the file managing device 50 displays detailed information about the completed part (the image to be output 114) of the part selected in the information display section 266 on the display of the workstation 12.

When the browsing button 282 is clicked, the file managing device 50 displays images of both the source part (the RGB image 104 or the rough image 108) and the completed part (the image to be output 114) of the part selected in the information display section 266 side by side on the display of the workstation 12.

That is, the operator can check the completion status (the progress of operations) of each part by checking the information or images for the source part and/or completed part displayed when the source part details button 278, the completed part details button 280, or the browsing button 282 is clicked.

Moreover, when the manuscript delivery state management button 284 is clicked, the file managing device 50 displays the above-described manuscript delivery state management screen 230 on the display of the workstation 12.

<Page Management Screen>

In FIG. 18, an example of the page management screen 290 is shown. On the upper part of the page management screen 290, a product selecting column 292 and a received manuscript group selecting column 294 are provided.

Each of the product selecting column 292 and the received manuscript group selecting column 294 is formed as a pull-down menu, so that an operator can select a desirable brochure from the brochures (products) which have been registered through the general management screen 200, and then select a desirable received manuscript group from the received manuscript groups which have been registered for the brochure selected through the manuscript delivery state management screen 230. The brochure and the received manuscript group which have been selected on the manuscript delivery state management screen 230 when the parts management button 250 was clicked on the manuscript delivery state management screen 230, are selected immediately after the page management screen 290 is displayed.

An information display section 296 is provided under the received manuscript group selecting column 294. In the information display section 296, information, for the received manuscript group selected in the product selecting column 292 and the received manuscript group selecting column 294, such as the received manuscript group (the name of the received manuscript group), the file name (the file name of the page data), a Check-in status (i.e., whether the page data is in the middle of modification (editing operation) or not, and “being modified” is displayed during modification), the number of pages (the number of pages contained in the page data), a Preflight status (the execution status (done/undone) of Preflight), the result of Preflight (the number of pages of PrintReadyPDF 130B), and the like is displayed for every page data (the application data 102 and the PDF page data 110). An operator can grasp the progress of page editing operations for each page data from the information displayed in the information display section 296.

Moreover, a delete button 298, a regeneration button 300, and a close button 302 are provided under the information display section 296. An operator can delete page data (i.e., delete the corresponding application data 102, PDF page data 110, page PS 112, page PDF 122, ProbeEPS 124, PrintReadyPDF 130B (or CheckReadyPDF 130A), and the like from the database 40), update the displayed information in the information display section 296 to the latest information, and close the page management screen 290 by clicking the respective buttons if necessary.

Further, a Check-in button 304, a Check-out button 306, a Preflight button 308, and a manuscript delivery state management button 310 are provided between the received manuscript group selecting column 294 and the information display section 296.

When the Check-in button 304 is clicked (i.e., a Check-in operation of a page is requested by an operator), the file managing device 50 modifies the Check-in information for the page data (CheckReadyPDF 130A) selected in the information display section 296 to “permitted”, and then manages the page data as a PrintReadyPDF 130B.

When the Check-out button 306 is clicked, the file managing device 50 modifies the Check-in information about the page data (PrintReadyPDF 130B) selected in the information display section 296 to “not permitted”, and then manages the page data as a ChechReadyPDF 130A.

When the Preflight button 308 is clicked, the OPI filter 48 is instructed to execute Preflight on the page data (page PDF 122) selected in the information display section 296.

When the manuscript delivery state management button 310 is clicked, the file managing device 50 displays the above-described manuscript delivery state management screen 230 on the display of the workstation 12.

(Illustrative Structure of Screen for Scanner)

Various types of screens which are displayed on the display of the scanning computer 24 when an operator starts the scanner application 34 to perform a reading operation of images by using the scanner 14, will now be described.

<Image Selection Screen>

In FIG. 19, an example of an image selection screen 320 which is displayed for selecting an image for which a reading (re-scanning) operation is to be performed is shown.

On the upper part of the image selection screen 320, a product selecting column 322, and a received manuscript group selecting column 324 are provided. Each of the product selecting column 322 and the received manuscript group selecting column 324 is formed as a pull-down menu, so that an operator can select a desirable brochure from the brochures (products) which have been registered through the general management screen 200, and then select a desirable received manuscript group from the received manuscript groups which have been registered for the brochure selected through the manuscript delivery state management screen 230.

An image display section 326 is provided under the received manuscript group selecting column 324. In the image display section 326, the names (file names) of rough images 108 belonging to the received manuscript group selected in the product selecting column 322 and the received manuscript group selecting column 324 are displayed with icons 328. That is, the names of the rough images 108 stored in the group folder 64 corresponding to the selected received manuscript group in the source parts folder 62B and icons 328 are displayed. A design of each icon 328 is a reduced image (a thinned image) of the corresponding rough image 108.

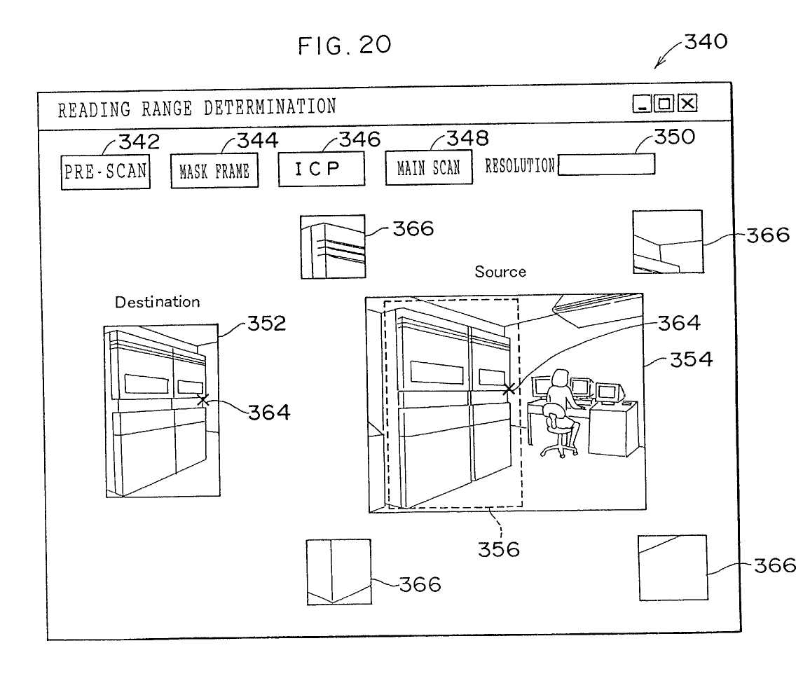

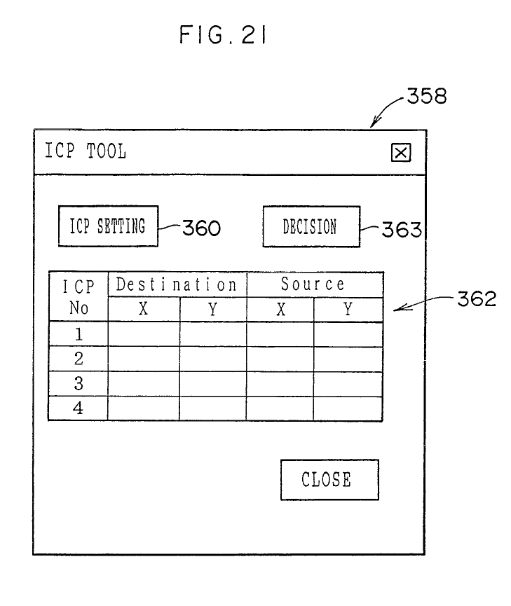

A selection button 330 and a close button 332 are provided under the image display section 326. When the selection button 330 is clicked, the scanning computer 24 selects the rough image 108 corresponding to the icon 328 which has been selected in the image display section 326 as a target image to be read from the positive film 106, and displays a reading range determination screen 340 on the display of the scanning computer 24 (see FIG. 20). When the close button 332 is clicked, the image selection screen 320 is closed.

<Reading Range Determination Screen>

In FIG. 20, an example of the reading range determination screen 340 is shown.

On the upper part of the reading range determination screen 340, a pre-scan button 342, a mask frame button 344, an ICP (Image Control Point) button 346, a main scan button 348, and a resolution entering column 350 are provided. Moreover, under these buttons, a reference image display region 352 in which an image used as a reference (a reference image: Destination) for an image reading operation is displayed, and a read image display region 354 in which a target image for the reading operation (a target image to be read: Source) is displayed are provided. In the reference image display region 352, the rough image 108 which has been selected on the above-described image selection screen is displayed as a reference image.

When the pre-scan button 342 is clicked by an operator by handling a mouse or the like, a pre-scan operation to read the entire manuscript of the positive film 106 which has been set in the scanning device 22 is performed by the scanning device 22. That is, the operator sets the positive film 106 corresponding to the rough image 108 displayed in the reference image display region 352, and then clicks the pre-scan button 342 to execute the pre-scan operation of the positive film 106 corresponding to the rough image 108. In the read image display region 354, the image which has been read in the pre-scan operation is displayed as the target image to be read.

When the mask frame button 344 is clicked, a mask frame 356 indicating the reading range (trimming range) is displayed in the read image display region 354. Each edge of the mask frame 356 can expand and contract in accordance with the operation of a mouse or the like by an operator, thereby changing the range of the mask frame 356.

When the ICP button 346 is clicked, an ICP tool 358 is displayed (see FIG. 21). In the ICP tool 358, an ICP setting button 360, an ICP information display section 362, and a decision button 363 are provided.

When the ICP setting button 360 is clicked, an ICP mark 364 is displayed on the reference image displayed in the reference image display region 352 and on the target image to be read displayed in the read image display region 354. The ICP mark 364 can be moved to any position on the reference image and on the target image to be read in accordance with the operation of a mouse or the like by an operator.

An operator handles a mouse or the like to move the ICP mark 364 on each of the reference image and the target image to be read to the position respectively pointing the same place in both images to thereby set the ICP. In the ICP information display section 362, the coordinates of the set ICP are displayed respectively for the reference image and target image to be read.

A new ICP mark 364 is displayed respectively on the reference image displayed in the reference image display region 352 and on the target image to be read displayed in the read image display region 354 every time when the ICP setting button 360 is clicked. That is, a plurality of ICPs can be set.

When the decision button 363 is clicked, the scanning computer 24 calculates affine transformation factors according to the set ICPs, such that positions of corresponding ICPs on the reference image and on the target image to be read coincide with each other. In order to calculate affine transformation factors, three or more ICP points are necessary. If four or more ICP points are set, affine transformation factors are determined by a method of least squares or the like.

Moreover, when the target image to be read is subjected to an affine transformation in accordance with the calculated affine transformation factors, the scanning computer 24 obtains a range of the target image to be read which will be identical to the range of the reference image (the region shown in the reference image) and automatically sets the obtained range as the reading range. Further, the mask frame 356 which has been set in accordance with the reading range is displayed on the target image to be read displayed in the read image display region 354 so that an operator can check the reading range which has been set automatically.

In order to set the reading region more accurately, confirmation screen display regions 366 are provided in the vicinity of each of the four corners of the read image display region 354. In each of the confirmation screen display regions 366, an image is displayed which is formed by superposing the rough image 108 and one of the corner images corresponding respectively to the target image to be read within the mask frame 356, i.e., within the reading range, and then by enlarging the superposed images. An operator can confirm from the images displayed in the confirmation screen display regions 366 whether each of the four corners of the reading range coincides with each of the four corners of the rough image 108.

In order to further facilitate the confirming operation by the operator, different colors may be applied to the rough image 108 and to the target image to be read such that, for example, R (red) is applied to R (red) element images in the rough image 108 and G (green) is applied to R (red) element images in the target image to be read, and then both images are superposed to be displayed. In this case, the operator can judge misalignment between the reading region and the rough image 108 from the superposed image displayed in the read image display region 354 when the operator checks the applied colors such as R and G to the rough image 108 and/or the target image to be read.

In the resolution entering column 350, the resolution of an image to be placed on a page, that is, the resolution of an image to be created (an image to be output 114) is entered (set) by an operator by means of a keyboard or the like.

When the main scan button 348 is clicked, the scanner 14 reads the image within the range shown in the mask frame 356 (i.e., a main/actual scanning) from the positive film 106 placed in the scanning device 22. The image reading resolution at this point is automatically calculated on the basis of the reading range, the resolution set in the resolution entering column 350, and the information about images (such as resolution and the number of pixels) obtained from the rough image 108.

(Outline of Process)

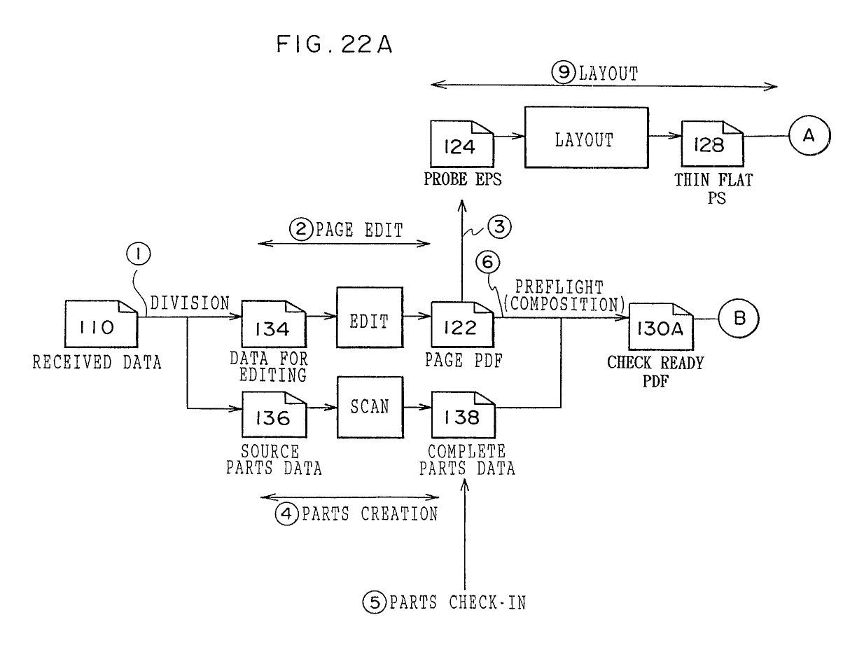

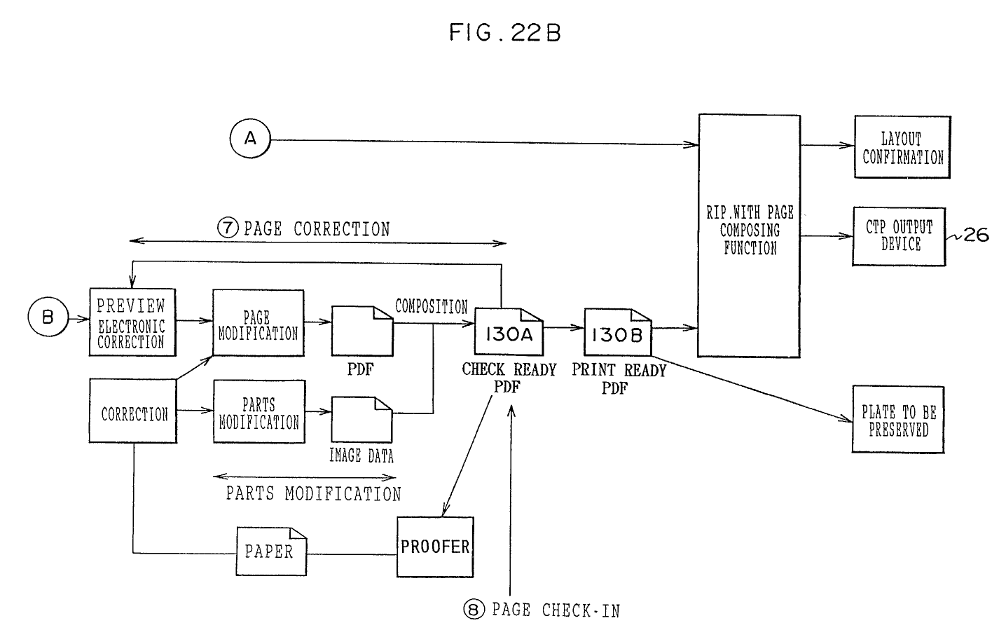

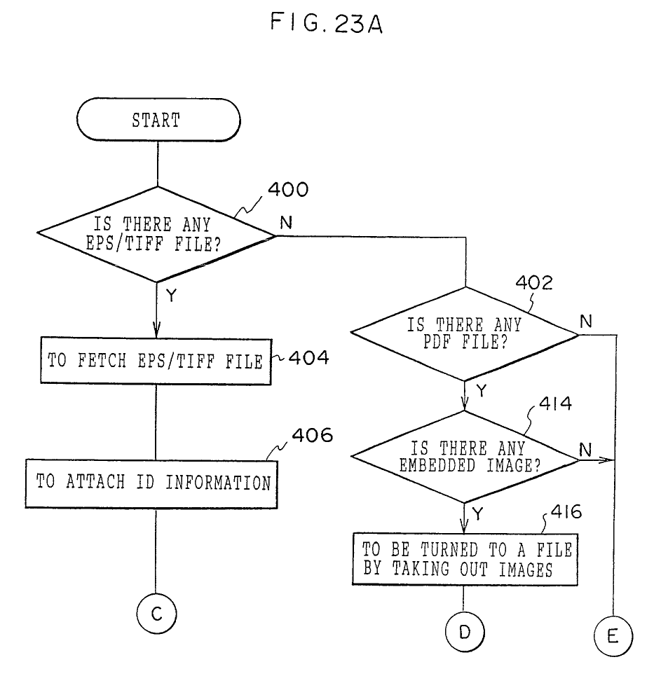

Operation of the present embodiment will be described hereinafter. In FIGS. 22A and 22B, flows of operations performed by an operator are illustrated. First, an outline of processes performed in the CTP system in accordance with the present invention will be described in order of arrows \mathring{1} to \mathring{8} in FIGS. 22A and 22B.

As preparations for creating a press plate by the CTP system 10, an operator creates folders (a brochure folder 60, data folders 62, and group folders 64), in advance, in the database 40 for the brochure (product) for which the press plate is created by registering the brochure (product) for which the press plate is created and its received manuscript groups by using the general management screen 200 and the manuscript delivery state management screen 230 (see “Preparation” section described later).

\mathring{1}: When the received data 100 (application data 102, rough images 108, RGB images 104, and/or PDF page data 110A) are received from a designing company or the like, the received data are stored in a received manuscript folder 62A.

When the received data 100 are stored in the received manuscript folder 62A, the OPI daemon 42 creates an image for editing 118 to which the ID information 116 is added for the Preflight operation (i.e., replacing operation by the OPI filter described later) and divides all the data into the data for editing 134 (application data 102, images for editing 118, and/or PDF page data 110B) and the source parts data 136 (rough images 108 and/or RGB images 104) (see “Creating Operation of Image for Editing” section described later). Accordingly, an operator can perform a page editing operation and a parts creating operation simultaneously.

\mathring{2}: In the page editing operation, an editing operation is performed by using the image for editing 118 to output a page PS 112, which is then converted to a page PDF 122 by a PS/PDF converter (see “Page Editing” section described later).

\mathring{3}: Immediately after the page PDF 122 is created, a ProbeEPS 124 is created by the OPI link 46 (see “Page Editing” section described later). Accordingly, an operator can also perform a layout operation together with the editing operation and the parts creating operation simultaneously.

\mathring{4}: In the parts creating operation, re-scanning, color conversion (RGB to CMYK), or retouch of the image, processing or modification of illustration parts, or the like are performed to create the image to be output 114 (see “Parts Creation” section described later).

\mathring{5}: With respect to the received manuscript group whose images to be output 114 are all provided, the Check-in operation of parts is performed. Access to the parts by the OPI filter 48 is not allowed until the Check-in operation has been done (see “Check-In Operation of Parts” section described later).

\mathring{6}: When the page editing operation is finished and all the necessary images to be output 114 are provided by means of the parts creating operation, the Preflight operation is performed to create page data to be output 130 (CheckReadyPDF 130A) (see “Preflight” section described later). When the above-described Check-in operation (\mathring{5}) has not been performed, the Preflight operation is cancelled, thereby preventing the parts data which is under preparation from being embedded in the page data to be output 130.

\mathring{7}: An operator checks problems occurred during printing by outputting the page data to be output 130 (CheckReadyPDF 130A) on a paper by a Proofer, for example, and solves the problems (see “Page Correction and Modification of Parts” section described later).

\mathring{8}: When the problems are solved, the Check-in operation is performed for the page data to be output 130 (CheckReadyPDF 130A) (see “Check-In Operation of a Page” described later). Due to the Check-in operation, the page data to be output 130 are managed as the PrintReadyPDF 130B and become transmissible to the RIP 18, thereby preventing fade data to be output 132 from being created by using the page data to be output 130 (CheckReadyPDF 130A) in the middle of the page correction.

\mathring{9}: In the layout operation, pages are laid out by using the ProbeEPS 124, and then the placement of each page on the press plate face (the placement position, the top and bottom, affine transformation information such as scaling and rotation) and the placement of register marks and the like are determined (see “Layout” section described later).

When the layout operation is completed, a ThinFlatPS 128 is created on the basis of the result and is then output to the RIP 18. Since the ProbeEPSes 124 are embedded in the ThinFlatPS 128, the placement information of the page can be taken out therefrom.

In the RIP 18, the PrintReadyPDF 130B is developed on the basis of the placement information, is composed with the ThinFlatPS 128 (page composition), and is then output to the CTP output device 26 (see “Rasterization” section described later).

(Detailed Description of Each Process)

The above-described each process will now be described in detail hereinafter. A case in which the brochure (product) named “Computer Communications” shown in FIG. 13 is created, that is, a case in which data for the brochure are divided into three received manuscript groups (i.e., “cover”, “Y2K”, and “advertisement”) and respectively received from a designing company or the like, will be described as an embodiment. For example, a folder named “Y2K” existing in a folder named “received manuscript” in a folder named “Computer Communications” is shown as “\Computer Communications\received manuscript\Y2K” by using the folder path.

<Preparations>

An operator makes the general management screen 200 and manuscript delivery state management screen 230 displayed on the display of the workstation 12, and registers the brochure (product) for which an order has been received and the received manuscript groups for the brochure in advance.

Due to the registration of the brochure, a brochure folder 60 for “Computer Communications” is created in the database 40, and a received manuscript folder 62A, a source parts folder 62B, a completed parts folder 62C, a page PS folder 62D, a page PDF folder 62E, a PrintReadyPDF folder 62F, and a ProbeEPS folder 62G are created in the brochure folder 60.

Moreover, due to the registration of the received manuscript groups, three group folders 64 (i.e., “cover”, “Y2K”, and “advertisement”) are created respectively in the received manuscript folder 62A, the source parts folder 62B, the completed parts folder 62C, the page PS folder 62D, the page PDF folder 62E, the PrintReadyPDF folder 62F, and the ProbeEPS folder 62G (see FIG. 14).

When the data are received from a designing company or the like, an operator copies the received data as received data 100 to the corresponding group folder 64 in the received manuscript folder 62A. For example, when the data for “Y2K” of “Computer Communications” are received in the form of MO or the like, data recorded onto the MO are copied to the folder “\Computer Communications\received manuscript\Y2K” (i.e., the folder named “Y2K” in the folder named “received manuscript” in the folder named “Computer Communications”, and folder paths will be represented in the same manner hereinafter) in the database 40. At this time, if there are subfolders in the MO, folders including those subfolders are copied altogether.

When the copying operation of the received data 100 is completed, an operator clicks the received manuscript check button 254 on the manuscript delivery state management screen 230 to check whether a file having the same file name as that of the one copied by the copying operation exists or not. If the operator is informed of the existence of such a file that has the same file name, the operator changes the file name of the copied file.

The name changing operation is performed in order to prevent occurrence of troubles such as overwriting the existing file by another file which has the same file name as that of the existing file and is moved to the folder at later time. Moreover, if files having the same file name do not exist, it is no longer necessary to create subfolders in the group folders 64 in the data folders 62 except in the received manuscript folder 62A. For example, subfolders do not exist in the folder “Computer Communications\source parts\Y2K”.

<Creation of Image for Editing>

(A) Creation of Image for Editing Having an AliasEPS Format

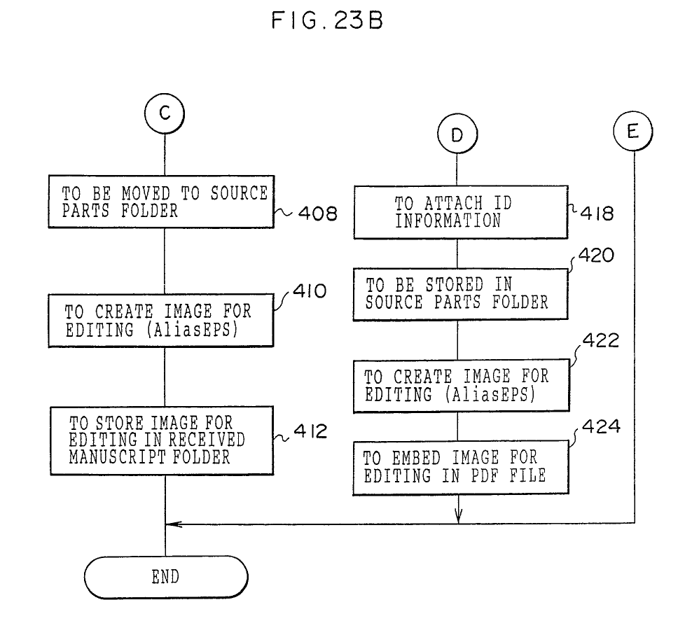

The OPI daemon 42 constantly monitors the received manuscript folder 62A. When received data 100 is stored in the received manuscript folder 62A, the OPI daemon 42 performs the processes illustrated in FIGS. 23A and 23B to create an image for editing with an AliasEPS format 118A.

When the received data 100 is stored in the received manuscript folder 62A, the OPI daemon 42 determines whether there exists an EPS file or a TIFF file in the received data 100 (step 400). If an EPS file or a TIFF file does not exist therein, the OPI daemon 42 determines whether a PDF file exists therein (step 402).

If an EPS file or a TIFF file exists therein, that is, an RGB image 104 or a rough image 108 with the EPS or TIFF file format is received together with the application data 102, the process proceeds to step 404. If PDF page data 110 is received, that is, the OPI daemon 42 confirms the existence of the PDF file, the process proceeds to step 414 (described later).

In step 404, the EPS file or TIFF file is fetched from the received data 100 as the source parts data 136. That is, the RGB image 104 and/or the rough image 108 are fetched from the received data 100 as the source parts data 136. If the file is a TIFF file, the file is converted to an EPS file at the time of being fetched.

Next, in step 406, the ID information 1 16A is added to each of the source parts data such as the fetched RGB image 104 or rough image 108. Then, in step 408, the source parts data 136 are moved to the corresponding group folder 64 in the source parts folder 62B.

For example, in a case in which a rough image 108 named “KeyBoard.eps” is fetched from “\Computer Communications\received manuscript\Y2K”, the ID information 116A containing “\Computer Communications\source parts\Y2K\KeyBoard.eps” is added thereto and then moved to “\Computer Communications\source parts\Y2K”.

Next, in step 410, an image for editing with an AliasEPS format 118A is created from the RGB image 104 or the rough image 108 moved to the source parts folder 62B. More specifically, low resolution image data 120A is created by thinning the RGB image 104 or the rough image 108. Accordingly, the low resolution image data 120A turns out to be an EPS file. The ID information 116A added to the source RGB image 104 or the rough image 108 is attached to (embedded in) the resulting EPS file as a comment, thereby creating an image for editing with an AliasEPS format 118A.

For example, to an image for editing with an AliasEPS format 118A which is created from the rough image 108 named “KeyBoard.eps” and is moved to “\Computer Communications\source parts\Y2K”, the ID information 116A containing “\Computer Communications\source parts\Y2K\KeyBoard.eps” is attached.

Then, in step 412, the created image for editing with an AliasEPS format 118A gets the same file name as that of the source RGB image 104 or rough image 108, and is stored in the group folder 64 in the received manuscript folder 62A in which the source RGB image 104 or rough image 108 has been existed (for example, “\Computer Communications\received manuscript\Y2K”). Then, the process ends.

On the other hand, in step 414, it is determined whether an image such as an RGB image 104 or a rough image 108 is embedded in the PDF page data 110 having a PDF format. When such an image is embedded therein, the process proceeds to step 416 in which the image of the embedded RGB image 104 or rough image 108 is fetched from the PDF page data 110 to thereby make the file an EPS file.

At this time, in the present embodiment, only those images needed to be reprocessed, that is, only those images (parts) for which images to be output 114 are needed to be created separately by the parts creating operation (described later), are fetched. For example, an image which has been color separated into RGB needs to be converted to a CMYK image. Moreover, an image having a certain resolution or lower also needs to be read again from the positive film 106 with a higher resolution.

Therefore, in step 414, each image embedded in the PDF page data 110 having a PDF format is checked whether the image is an image with the RGB color separation or an image with a certain resolution or lower. In step 416, such images that fail to pass the check are fetched and turned to files, that is, the images with the RGB color separation are fetched as RGB images 104, and the images with a certain resolution or lower are fetched as rough images 108 and then these images are turned to files.

By fetching only those images needed to be reprocessed in such a manner, it is possible to try to improve the working efficiency. Moreover, such images that need to be reprocessed are checked and fetched automatically, so that fetching errors can be prevented.

Next, in step 418, the ID information 116A is attached, in the same manner as in step 406, to the RGB image 104 or the rough image 108 which has been turned to an EPS file. In step 420, in the same manner as in step 408, the RGB image 104 or the rough image 108 turned to an EPS file is moved to the corresponding group folder 64 in the source parts folder 62B.

In step 422, in the same manner as in step 410, an image for editing with an AliasEPS format 118A is created from the RGB image 104 or the rough image 108 moved to the source parts folder 62B.

Next, in step 424, the created image for editing with an AliasEPS format 118A is embedded, instead of the fetched RGB image 104 or rough image 108, in the PDF page data 110 (thereby producing a PDF page data 1 10B). Then, the process ends.

Accordingly, when an operator opens the application data 102 or the PDF page data 1 10B by an editing application, the images for editing with an AliasEPS format 118A are displayed in place of parts such as the RGB image 104 and the rough image 108. The operator performs the page editing operation by using the images for editing with an AliasEPS format 118A. Also, the operator performs the parts creating operation (such as re-scanning, color modification, and retouch of images) by using the RGB image 104 or the rough image 108 moved to another folder (the source parts folder 62B). That is, the page editing operation and the parts creating operation can be performed separately.

While the file is converted to an EPS file to create an image for editing with an AliasEPS format 118A in a case in which the RGB image 104 or the rough image 108 is a TIFF file in the above-described embodiment, an image for editing with a TIFF file format may be created instead of converting to an EPS file. In this case, the ID information 116A will be the file name thereof.

Moreover, while an image for editing with an AliasEPS format 118A is created by turning the RGB image 104 or the rough image 108 fetched from the PDF page data 110 to an EPS file in the present embodiment, an image for editing with a TIFF file format may be created by turning the file to a TIFF file. In this case, the ID information 116A will be the file name thereof.

Further, when the RGB image 104 and/or the rough image 108 with an EPS or TIFF file format are received together with the application data 102, the RGB image 104 and/or the rough image 108 may be copied and the copies are stored in the source parts folder 62B instead of fetching and moving them. If an image for editing with an AliasEPS format 118A is created from the copy and is used to replace the RGB image 104 or the rough image 108 which is the source of the copy, the same effect can be obtained.

Similarly, when PDF page data 110 in which an RGB image or a rough image 108 is embedded is received, the RGB image 104 or the rough image 108 may be copied and the copy is turned to a file which may be stored in the source parts folder 62B, instead of fetching, turning to a file, and moving to the source parts folder 62B. If an image for editing with an AliasEPS format 118A is created from the copy and is embedded in the PDF page data 110 in place of the RGB image 104 or the rough image 108 which is the source of the copy, the same effect can be obtained.

(B) Creation of Image for Editing with BlankEPS Format

Among the parts which construct a page, images for advertisement, for example, may occasionally be received later in the form of the image data with high resolution and high quality which can be used for the press plate creation as it is (EPS file).

An operator (edit operator) checks whether unreceived parts exist or not after he/she copies the received data 100 to the corresponding group folder 64 in the received manuscript folder 62A. If there exists any unreceived part, the operator (edit operator) uses a mouse, a keyboard or the like to enter the size, the title, the expected date of delivery, the manuscript delivering party or the like of the unreceived part in a BlankEPS creation screen (not shown), thereby instructing the creation of the image for editing 118 with respect to the unreceived part.

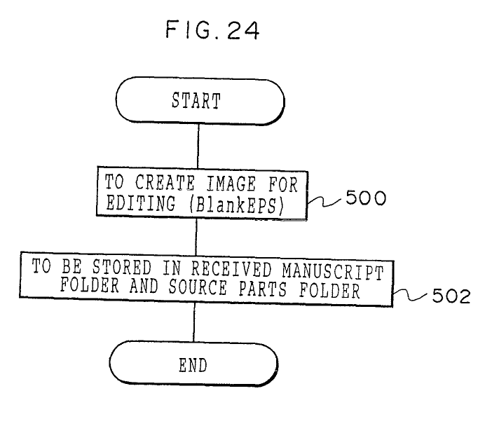

Upon receiving the instruction to create the image for editing 118 with respect to the unreceived part, the OPI daemon 42 performs the processes illustrated in FIG. 24 to create an image for editing with a BlankEPS format 118B.

That is, when the creation of the image for editing 118 with respect to the unreceived part is instructed, the OPI daemon 42 creates an image for editing with a BlankEPS format 118B under the instruction (step 500).

More precisely, low resolution image data 120B is created by thinning a preview screen having a term “unreceived” together with the character strings such as the title, the expected date of delivery, and the manuscript delivering party of the parts data entered by the operator, and the same image size as the size of the entered unreceived part, and then the created file is turned to an EPS file. The ID information 116B indicating the correspondence between the EPS file and the data to be received is attached to (embedded in) the EPS file as a comment, thereby creating the image for editing with a BlankEPS format 118B.

For example, the ID information 116B containing “Computer Communications\completed parts\Y2K\PC1.eps” is attached to the image for editing with a BlankEPS format 118B which is created in a case in which “PC1.eps” is received later as the image to be output 114.

Next in step 502, the created image for editing with a BlankEPS format 118B is stored in the group folder 64 corresponding to the data to be received in the received manuscript folder 62A (in the above-described example, the folder “Computer Communications\received manuscript\Y2K”). The identical image for editing with a BlankEPS format 1 18B is stored also in the group folder 64 corresponding to the data to be received in the source parts folder 62B (in the above-described example, the folder “Computer Communications\source parts\Y2K”). Then, the process ends.

An operator performs the page editing operation by using the image for editing with a BlankEPS format 118B as an alternative part for the unreceived part.

<Parts Creation>

(A) Re-scanning

At the designing company or the like, a rough image 108 is created by using a low-priced scanner, and then the layout of the corresponding parts is determined with the created rough image 108 by an editing application. Since the rough image 108 has a low quality, it is necessary to read the image again from the positive film 106 by using the scanning device 22 for plate making to create an image to be output 114 with high quality.

An operator (parts creation operator) makes the image selection screen 320 displayed on the display of the scanning computer 24 and clicks the selection button 330 to select the rough image 108 which is necessary to be scanned again. Accordingly, the reading range determination screen 340 is displayed on the display of the scanning computer 24. At this time, the selected rough image 108 is displayed in the reference image display region 352.

Then, the operator (parts creation operator) sets the positive film 106 corresponding to the selected rough image 108 in the scanning device 22 and clicks the pre-scan button 342 to pre-scan the positive film 106. The image read by the pre-scan operation is displayed in the read image display region 354. As a result, the rough image 108 and the image read from the positive film 106 by the pre-scan operation are displayed side by side in the reading range determination screen 340.

The operator (parts creation operator) determines the reading range (trimming range) for the main scan operation such that the image spacing thereof becomes the same as that of the rough image 108.

For example, if there exists a distinctive image structure in an end (or boundary) portion of the rough image 108, the operator clicks the mask frame button 344. Then, the operator handles a mouse or the like to expand and contract each edge of the mask frame 356 so that the image spacing of the range within the mask frame 356 of the target image to be read becomes the same as that of the rough image 108 (i.e., so that the region shown in the mask frame 356 becomes identical to the region shown in the reference image) to thereby set the reading range manually (thereby setting the starting point and the termination point of the reading range).

On the other hand, if there is no distinctive image in an end (or boundary) portion of the rough image 108, it is difficult for the operator to set the mask frame 356 manually, so that the operator clicks the ICP button 346 to make the ICP tool (screen) 358 displayed. The operator then clicks the ICP setting button 360 to display the ICP marks 364 on the reference image and the target image to be read. The operator moves the ICP mark 364 respectively on the reference image and the target image to be read to the position pointing the same feature (i.e., to the position where the identical image is shown), thereby setting the ICP.

When the operator sets at least three ICPs in this way and then clicks the decision button 363, the scanning computer 24 automatically calculates affine transformation factors and sets the reading range. Since the ICPs are set manually by the operator, it is preferable to set four or more ICPs taking a setting error into consideration.

Moreover, at this time, an image formed by superposing the rough image 108 and the target image to be read within the reading range is enlarged and displayed in each of the confirmation screen display regions 366, so that the operator checks whether the reading range has the same image spacing as that of the rough image 108 or not.

When the reading range is determined, the operator specifies the resolution of the image to be created (image to be output 114) by entering a desired resolution in the resolution entering column 350 and then clicks the main scan button 348 to instruct the execution of the main scan.

Upon receiving the instruction to execute the main scan, the scanner 14 automatically determines the reading resolution on the basis of the reading range, the resolution set in the resolution entering column 350, and the image information (such as resolution and the number of pixels) obtained from the rough image 108. In this way, a suitable reading resolution is automatically determined (i.e., calculated by computation), so that it is not necessary for the operator to enter parameters for scanning, thereby preventing entering errors.

The image information about the rough image 108 signifies the reading resolution (referred to as “resolution”, hereinafter) at the time of creation of the rough image and the image size (referred to as “the number of pixels”, hereinafter). In the present embodiment, it is assumed that the rough image 108 is either an EPS file or a TIFF file, and in general, such information is contained as the header information in the images of the EPS file and TIFF file.

When the reading resolution is determined, the scanner 14 reads images, in accordance with the resolution indicated in the information, from the positive film 106 to create images to be output 114 having an EPS file format. Moreover, the ID information 116A which has been attached to the corresponding rough image 108 is attached to the created image to be output 114 as a comment, and then the created image to be output 114 is stored in the corresponding group folder 64 in the completed parts folder 62C.

For example, when the image to be output 114 is created for the rough image 108 named “KeyBoard.eps” moved to “Computer Communications\source parts\Y2K”, the ID information 116A containing “Computer Communications\source parts\Y2K\KeyBoard.eps” is automatically attached to the image to be output 114 as a comment and the image to be output 114 is stored in “Computer Communications\completed parts\Y2K”.

Accordingly, the rough image 108, the image for editing with an AliasEPS format 118A created from the rough image 108, and the image to be output 1 14 created for the rough image 108 have the same ID information 116A.

That is, the ID information 116A which is identical to that of the image for editing with an AliasEPS format 118A corresponding to the image to be output 114 is automatically attached to the image for editing with an AliasEPS format 118A created from the rough image 108, so that the replacing process performed subsequently by the OPI filter 48 is executed accurately. Moreover, it is not necessary for the operator to enter the ID information, so that entering errors can be prevented.

Further, the created image to be output 114 is stored in the corresponding group folder 64 in the completed parts folder 62C (“Computer Communications\completed parts\Y2K” in the above-described example).

(B) Color Conversion

On the other hand, in the case of RGB image 104 obtained by a digital camera or the like, it is necessary for the image to be color converted to a CMYK image. In this case, an operator (parts creation operator) enters instructions to set up the color conversion for the RGB image 104 in the source parts folder 62B, so that the colors are converted to the colors suitable for printing. Moreover, in a case in which the RGB image 104 is a TIFF file, the image is converted to an EPS file (format conversion).

The color-converted image (format conversion has also been applied, if necessary) is stored as an image to be output 114 in the corresponding group folder 64 in the completed parts folder 62C (“Computer Communications\completed parts\Y2K” in the above-described example). At this time, the ID information 1 16A attached to the RGB image 104 prior to conversion is also attached as a comment to the image to be output 114.

Accordingly, the RGB image 104, the image for editing with an AliasEPS format 118A created from the RGB image 104, and the image to be output 114 created by color converting the RGB image 104 have the same ID information 116A. That is, the ID information 1 16A which is identical to that of the image for editing with an AliasEPS format 118A corresponding to the image to be output 114 is automatically attached to the image to be output 114 created by color converting the RGB image 104, so that the replacing process performed subsequently by the OPI filter 48 is executed accurately. Moreover, it is not necessary for the operator to enter the ID information, so that entering errors can be prevented.

(C) Unreceived Part

When images which have been unreceived are received, an operator (parts creation operator) copies the received images (the images to be output 114 received with some delay) in the corresponding group folder in the completed parts folder 62C (“Computer Communications\completed parts\Y2K” in the above-described example).

At this time, the operator specifies, on a BlankEPS specifying screen (not shown), an image for editing with a BlankEPS format 118B corresponding to the image to be output 114 received with some delay. The file managing device 50 reads the ID information 116B attached to specified image for editing with a BlankEPS format 118B and attaches (embeds) the ID information 116B as a comment to the image to be output 114 received with some delay.

That is, the ID information 116B which is identical to that of the image for editing with a BlankEPS format 118B corresponding to the image to be output 114 is automatically attached to the image to be output 114 received with some delay. Accordingly, the replacing process performed subsequently by the OPI filter 48 is executed accurately. Moreover, it is not necessary for the operator to enter the ID information, so that entering errors can be prevented.

<Check-In Operation of Parts>

An operator (administrator) makes the parts management screen 260 displayed on the display of the workstation 12 and checks whether all the parts (images to be output 114) are provided for every received manuscript group.

More precisely, for a part which has been modified by rescanning, color conversion or the like, there exists a file of an RGB image 104 or a rough image 108 in the source parts folder 62B and a file of an image to be output 114 in the completed parts folder 62C. For a part which has not been modified, the corresponding file (an RGB image 104 or a rough image 108) only exists in the source parts folder 62B. For an unreceived part, a file of an image for editing with a BlankEPS format 118B exists in the source parts folder 62B, and when the part is received, the received part, that is, the file of an image to be output 114 exists in the completed parts folder 62C.

The operator can grasp whether all the parts for the received manuscript group have been provided or not by checking, for example, whether the file corresponding to each part exists or not from the information displayed in the information display section 266 on the parts management screen 260.

The operator clicks the Check-in button 274 on the parts management screen 260 if all the parts are provided (Check-in operation of parts). Access to the parts by the OPI filter 48 is not allowed until the Check-in operation has been done. This is an essential function for the page editing operation and the parts creating operation to be executed in parallel.

<Page Editing>

As described above, the rough images 108 and/or the RGB images 104 among the received data 100 received from a designing company or the like have been replaced with the images for editing with an AliasEPS format 118A. Therefore, when an operator (edit operator) opens the application data 102 (or the PDF page data 110B) by an editing application, the images for editing with an AliasEPS format 118A are displayed in place of the parts such as the original rough images 108 and RGB images 104 (some editing applications according to types thereof may require confirmation from an operator).

When there exists any unreceived part and the images for editing 118B with a BlankEPS format are created, the operator (edit operator) places the images for editing 118B with a BlankEPS format in a page. Moreover, the operator changes the layout of the page (changing the placement of parts by moving the positions of the images for editing with an AliasEPS format 118A on the page or the like) if necessary.

When these operations are completed, the operator (edit operator) instructs the editing application 30 to output a page PS 112. At this time, the editing application 30 outputs the page PS 112 into the corresponding group folder 64 in the page PS folder 62D (“Computer Communications\page PS\Y2K” in the above-described example).

When the page PS 112 is stored in the page PS folder 62D, the PS/PDF converter 44 creates a page PDF 122 which has been converted from the page PS 112 to a form of PDF description. The created page PDF 122 is stored in the corresponding group folder 64 in the page PDF folder 62E (“Computer Communications\page PDF\Y2K” in the above-described example).

In the case of the PDF page data 10B, the result of the editing operation performed by the editing application has already been a form of PDF description, so that the conversion performed by the PS/PDF converter 44 is not necessary.

When the page PDF 122 is stored in the page PDF folder 62E, a ProbeEPS 124 is created for every page by the OPI link 46. The ID information 126 provided for identification of the source page PDF 122 and the page number is attached to the ProbeEPS 124 as a comment.

For example, if a page PDF 122 named “first part.pdf” in “Computer Communications\page PDF\Y2K” has the data for five pages, five files of ProbeEPS 124 are created. In the case of the ProbeEPS 124 corresponding to the third page among these ProbeEPSes, for example, information containing “first part.pdf” and “page 3” is attached thereto as the ID information 126. This ID information 126 is used as link information to the page data to be output 130 at the time of rasterization (described later).

In a case in which a modification that extends over pages is made after the page PDF 122 has once been created, it is necessary to re-create the page PDF 122 by performing modification operation by using the editing application 30 once again. That is, the page editing operation is performed by handling the once-created page PDF 122 as the PDF page data 110 to re-create the page PDF 122.

At this time, it is determined, in accordance with the result set (or selected) by the operator, whether the parts embedded in the page PDF 122 (images for editing 118) should be fetched or not. If the images are fetched from the page PDF 122, the fetched images are stored in the corresponding group folder 64 in the source parts folder 62B (“Computer Communications\source parts\Y2K” in the above-described example). If the images fetched previously should not be destructed, the operator creates a subfolder and moves the images fetched previously to the newly created subfolder. At this time, the operator may choose to create the image for editing with an AliasEPS format 118A in the corresponding group folder 64 in the received manuscript folder 62A (“Computer Communications\received manuscript\Y2K” in the above-described example).

<Preflight>

When the page editing operation and the parts creating operation are completed, an operator enters instructions to execute Preflight on the page PDF. This instruction is performed by clicking the Preflight button 308.

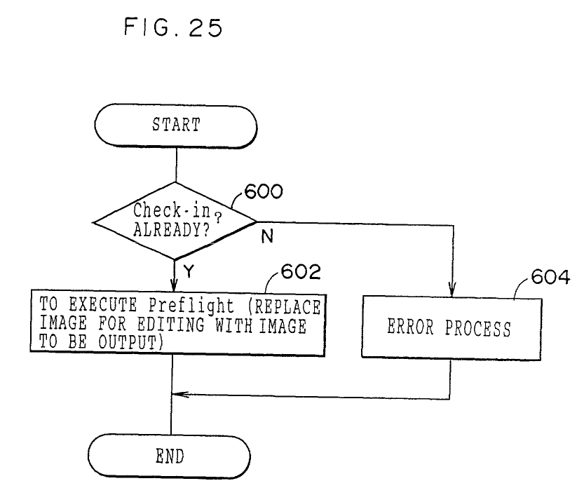

Upon receiving the instruction, the OPI filter 48 performs the processes illustrated in FIG. 25. First, in step 600, the OPI filter 48 determines whether the parts necessary for the execution of Preflight (images to be output 114) are accessible or not, that is, whether the Check-in operation for the parts corresponding to the page PDF 122 for which the execution of Preflight is instructed has been performed (i.e., whether the Check-in operation has been performed for the parts of the received manuscript group corresponding to the page PDF 122) or not.

When the Check-in operation has been performed, it is judged that all the necessary images to be output 114 are provided, so that the process proceeds to step 602, in which Preflight is executed. Accordingly, the images for editing 118 in the page PDF 122 are replaced with the corresponding images to be output 114 to create the page data to be output 130.

More precisely, the ID information 116 embedded in the image for editing 118 as a comment and the ID information 116 embedded in the image to be output 114 as a comment are compared, and then by replacing each image for editing 118 in the page PDF 122 with the images to be output 114 having the same ID information 116 as that of the image for editing 118, the image for editing 118 can be replaced with the corresponding image to be output 114 accurately.

The created page data to be output 130 is given a name identical to the file name of the source page PDF, and then stored in the corresponding group folder 64 in the PrintReadyPDF folder 62F (“Computer Communications\PrintReadyPDF\Y2K” in the above-described example).

The page data to be output 130 are managed as a CheckReadyPDF 130A until the Check-in operation for the page (described later) is carried out.

On the other hand, if the Check-in operation for the parts has not been performed, it is judged that not all the necessary images to be output 114 are provided, and the process proceeds to step 604. In step 604, an error process such as to display a message informing of the situation that the Check-in operation for the parts has not been carried out is performed and the process ends.

Accordingly, when the execution of Preflight is instructed mistakenly even if not all the images to be output 114 are provided, the execution of Preflight can be cancelled. That is, it is possible to prevent the unfinished parts data from being embedded in the page data to be output 130.

Moreover, when the Check-in operation for the parts has not been performed, it may be possible to warn the operator, for example, by displaying a message, on the display, indicating the probability that unfinished parts data might be embedded and then to perform Preflight.

<Page Correction and Modification of Parts>

When the page data to be output 130, that is, the CheckReadyPDF 130A is created, an operator (edit operator) performs a page correction by using the created files. At this time, in the CheckReadyPDF 130A, the images for editing with an AliasEPS format 118A have been replaced with the images to be output 114. Moreover, if the unreceived parts are received by this time, the images for editing with an AliasEPS format 118A are replaced with the images for editing with a BlankEPS format 118B.

Precisely, the following operations are assumed to be performed in the page correction.

Preview: to check placement or the like of the parts by making the CheckReadyPDFs 130A displayed on the display;

Electronic proofread: to send the CheckReadyPDFs 130A to a client (or the customer who ordered the creation of the brochure) by an e-mail or the like to ask to check the placement of the parts or the like; and

Color correction: to output the CheckReadyPDF 130A to a Page Proofer to check printed colors.

When the modification of parts placement is found out to be necessary as the result of checking the placement of parts in the preview or electronic proofread, the position of the corresponding part can be modified on the CheckReadyPDF 130A. When the preview or electronic correction is performed, the image for editing 118 is useful rather than the image to be output 114 since the file size of the former is smaller than that of the latter. That is, it may be possible to perform preview or electronic proofread by using the page PDF 122, in which the images for editing 118 are embedded, instead of the CheckReadyPDF 130A.

When the modification (re-scanning or image processing such as modification of density or the like) of parts (images to be output 114) is found out to be necessary as the result of checking the printed colors by the color correction, a modification operation for the corresponding parts is carried out. At this time, the Check-in state for the parts has to be released (by clicking the Check-out button 276) first, and the Check-in operation has to be performed once again (by clicking the Check-in button 274) when the modification operation has been completed. When Preflight is executed once again after performing a re-Check-in operation, a CheckReadyPDF 130A in which the modified images to be output 114 are embedded can be obtained.

<Check-In Operation of a Page>

When the page correction is completed, an operator (administrator) makes the page management screen 290 displayed, selects the information for the corresponding page data to be output 130 (CheckReadyPDF 130A) in the information display section 296 on the screen, and clicks the Check-in button 304 (Check-in operation of a page). Due to the Check-in operation of a page, the page data to be output 130 is managed as a PrintReadyPDF 130B which is permitted to be accessed by the RIP 18. That is, the page data to be output 130 can be transmitted to the RIP 18.

In this way, the page data to be output 130 are not allowed to be transmitted to the RIP 18 until the Check-in operation has been done, thereby preventing the page data to be output 130 (CheckReadyPDF 130A) which is in the middle of correction operation from being used in the rasterization process described later to output the fade data to be output 132. This is an essential function for the layout operation, the page correction operation, the parts creating operation and the parts modification operation to be executed in parallel.

When the Check-in operation for a page is performed, the page data to be output 130 (PrintReadyPDF 130B) is transmitted to the RIP 18 provided with the page composing device 52. In a case in which the system is not connected with such an RIP 18 that is provided with the page composing device 52, an EPS file is created for every page from the page data to be output 130 (PrintReadyPDF 130B) and is stored in an HDD or the like.

<Layout Operation>

An operator (layout operator) performs a layout operation (i.e., an operation to lay out pages, to be precise) by means of a layout application 32 using the ProbeEPS 124. When the layout operation is completed, the operator instructs the layout application 32 to output a ThinFlatPS 128.

The created ThinFlatPS 128 is transmitted to the RIP 18 provided with the page composing device 52. In the case in which the system is not connected with the RIP 18 provided with the page composing device 52, the created ThinFlatPS 128 is stored in the folder in which the ProbeEPS 124 has been existed (“Computer Communications\ProbeEPS\Y2K” in the above-described example).

<Rasterization>

Upon receiving the ThinFlatPS 128, the RIP 18 develops the ThinFlatPS 128 into a raster image (so-called “rasterization”) and creates a bitmap data (image) expressing the overall image of the press plate on which the ProbeEPSes 124 placed by the page layout operation, register marks and the like are placed.

Moreover, upon receiving the page data to be output 130 (PrintReadyPDF 130B), the RIP 18 retrieves, on the basis of the ID information 126, the ProbeEPS 124 in the ThinFlatPS 128 corresponding to the given page for every page of the page data to be output 130.

For example, from the ProbeEPS 124 corresponding to the third page of the page PDF 122 named “first part.pdf” in “Computer Communications\page PDF\Y2K”, the ID information 126 such as “first part.pdf” and “page 3” can be read out. Moreover, the same file name as the source page PDF 122 (“first part.pdf”) is given to the page data to be output 130 which has been created by performing Preflight on the page PDF 122. Therefore, the ProbeEPS 124 in the ThinFlatPS 128 whose ID information 126 contains “first part.pdf” and “page 3”can be associated with the third page of the page data to be output 130 in the file named “first part.pdf”.

The RIP 18 performs affine transformation (at least transformation of rotation and scaling components) on the basis of the placement information of the corresponding ProbeEPS 124 for every page of the received page data to be output 130, and then develops the affine transformed data into raster images (so-called “rasterization”) to create bitmap data (image) per page.

When all the bitmap data for the pages corresponding to all of the ProbeEPSes 124 in the ThinFlatPS 128 are provided, the bitmap data expressing the entire image of the press plate and the bitmap data for each page are composed (bitmap composition).

Accordingly, fade data to be output 132 in which each part of the ProbeEPS 124 on the bitmap data expressing the entire image of the press plate is replaced with the bitmap data per page created from the page data to be output 130 corresponding to the ProbeEPS 124, can be obtained.

The RIP 18 either stores the created fade data to be output 132 in an HDD or the like, or transmits it to the CTP output device 26. The CTP output device 26 creates a press plate on the basis of the fade data to be output 132.

In the case in which an RIP which is not provided with the page composing device 52, the page data to be output 130 (PrintReadyPDF 130B) is converted to an EPS file, gets a file name of the corresponding ProbeEPS 124, and is stored in an HDD or the like. When all the output version of the EPS files (i.e., the EPS files created from the page data to be output 130) are provided, the ProbeEPSes 124 in the ThinFlatPS 128 are replaced with the corresponding EPS files (i.e., the EPS files created from the page data to be output 130), and the resultant data are output to the RIP in the form of PS files. The RIP may develop the PS files into raster images to create fade data to be output.

(Generalization)

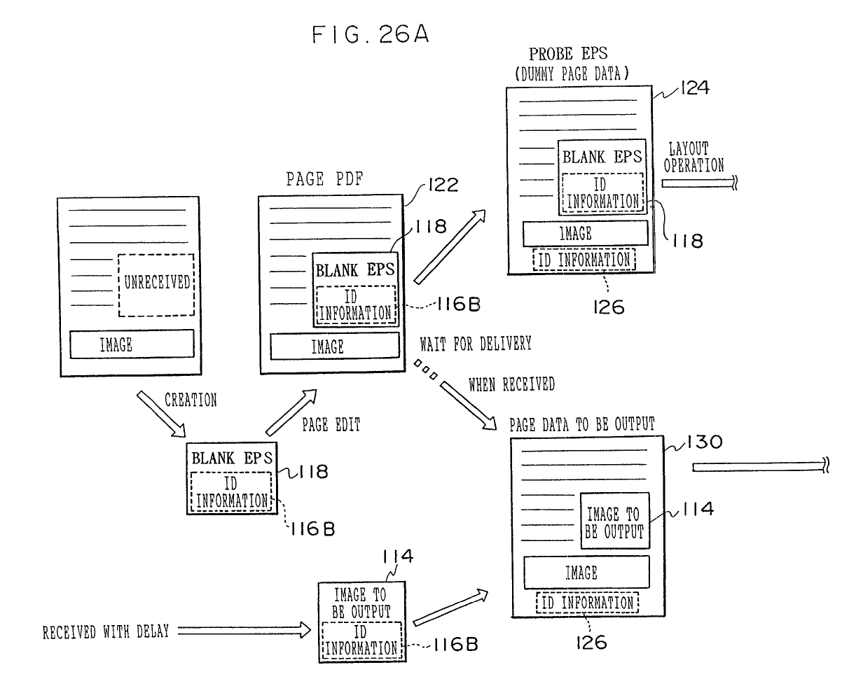

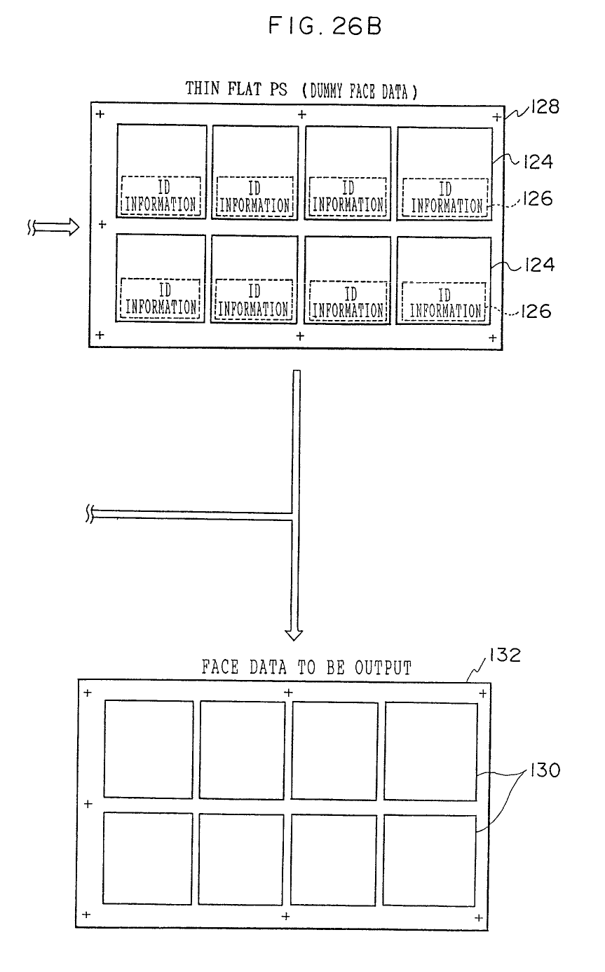

Referring to FIGS. 26A and 26B, processes in a case in which there exists any unreceived part will be outlined hereinafter. As described above, if there exists any unreceived part, an operator instructs the OPI daemon 42 to create an image for editing 118B after specifying the size and the like thereof. Accordingly, the OPI daemon 42 creates an image for editing with a BlankEPS format 118B to which the ID information 116B is attached as the information for replacing the parts. The operator can perform the page editing operation by using the image for editing with a BlankEPS format 118B as an alternative part for the unreceived part. That is, even if there exists any unreceived part, the page editing operation can be completed.

When the page editing operation is completed, the OPI link 46 creates dummy page data still using the image for editing 118, for every page on the basis of the results of page editing operation. That is, a ProbeEPS 124 to which the ID information 126 is attached as the information for replacement is created. The operator can perform the layout operation by using the ProbeEPS 124 as an alternative part for the actual page data to be output for each page. That is, even if there exists any unreceived part, dummy face data, i.e., ThinFlatPS 128, can be created by performing operations up to the layout operation in advance. The dummy face data uses the ProbeEPS 124 for the data for each page and expresses an image of the press plate face in a state in which the pages are allocated.

When the unreceived part (image to be output 114) is received and the image for editing with a BlankEPS format 118B corresponding to the received part is specified by an operator, the ID information 116B which is identical to that of the image for editing with a BlankEPS format 118B is attached to the received part. By referring to the ID information 116B, the image for editing with a BlankEPS format 118B is replaced by the image to be output 114 received with delay. Accordingly, the page data to be output 130 can be created.

If the image for editing with a BlankEPS format 118B and the image to be output 114 can be associated, the ID information 116B may be attached only to the image for editing 118B. However, in a case in which the file name of the image to be output 114 expected to be received is contained as the ID information 116B of the image for editing with a BlankEPS format 118B created for the unreceived part as in the present embodiment, if a file name different from the ID information 116B is given to the image to be output 114 received with delay, the correspondence between the image to be output 114 received with delay and the image for editing with a BlankEPS format 118B is thrown into disorder. Similarly, in a case in which the file name is changed after the data is received, the correspondence is thrown into disorder. Therefore, the ID information 116B is preferably attached to both of the image for editing with a BlankEPS format 11 8B and the image to be output 114.

Moreover, by referring to the ID information 126, the ProbeEPSes 124 in the ThinFlatPS 128 are replaced by the corresponding pages of the created page data to be output 130. Accordingly, the fade data to be output 132 can be created.

While the case in which the ID information 116 is attached, as a comment, to (embedded in) the image for editing 118 and the image to be output 114 for the replacing operation by the OPI filter 48 has been described above as an example, the present invention is not limited thereto. As long as the image for editing 118 and the image to be output 114 correspond with each other, the ID information 116 may be attached only to the image for editing 118.

If the replacing operation is performed in a condition in which the correspondence between the image for editing 118 and the image to be output 114 is managed (stored) by file names in the system, there is no need to embed the ID information 116. Moreover, the ID information 116 may be attached as a file name instead of a comment.

However, in the case in which the ID information 116 is attached as a file name, the replacing operation may result in failure when the file name of the image for editing 118 or the image to be output 114 is altered by an operator. In order to cope with the alteration of file names, it is preferable to attach the ID information 116 to both of the image for editing 118 and the image to be output 114 in a form, such as a comment, which does not change as the file name is changed.

The same idea may be applied to the ProbeEPS 124 and the page data to be output 130. That is, the ID information (the file name of the source page PDF 122 for example) may preferably be embedded as a comment in the page data to be output 130 in order to cope with the alteration of the file names.

Further, it may not be necessary to attach the ID information 116A to the rough image 108 and/or RGB image 104. For example, to the image for editing 118 and the image to be output 114, the file name of the rough image 108 or RGB image 104 corresponding to the image for editing 1 18 or the image to be output 114 may be attached as the ID information 116A. In order to cope with the alteration of the file names of the rough image 108 and/or RGB image 104, it is preferable to embed the ID information 116A.

As described above, the present invention has an excellent effect such that a page editing operation and a layout operation can be performed even if not all the parts are provided.

What is claimed is:

1. A method of creating data for printing when performing page editing operation on a computer, the method comprising the steps of:
(a) determining if there is any part of the page, for which corresponding parts data has not been received by the time of the page editing operation, and if so, creating dummy parts data for the unreceived parts data;
(b) creating dummy page data by inserting the dummy parts data for the unreceived parts data in a position on the page allocated for the unreceived parts data; and
(c) replacing the dummy parts data when the unreceived parts data is received, with the received parts data, for creating page data for printing.

2. The method of claim 1, wherein creating dummy parts data in the step of determining includes providing first information with the dummy parts data, and the step of replacing the dummy parts data includes referring to the first information.

3. The method of claim 2, wherein the first information includes data indicating a folder and a file in which the page data for printing is expected to be stored.

4. The method of claim 2, wherein the parts data when received, also includes the first information.

5. The method of claim 1, further comprising the steps of:
(a) performing a layout operation using dummy page data to create dummy plate face data; and
(b) creating plate face data for printing by replacing the dummy page data in the dummy plate face data when page data is available from the step of replacing dummy parts data.

6. The method of claim 5, wherein the step of creating dummy page data, includes providing second information with the dummy page data, and the step of creating plate face data includes referring to the second information.

7. The method of claim 6, wherein the second information includes data indicating a file and a page number in which the dummy page data is stored.

8. The method of claim 6, wherein the page data for printing, also includes the second information.

9. The method of claim 1, further comprising the step of inputting an instruction to determine if there is any part of the page for which corresponding parts data has not been received.

10. The method of claim 9, further comprising the step of terminating processing if the instruction has not been inputted.

11. A system for creating printing data during page editing and layout, the system comprising a data processing arrangement having program logic, the program logic including:
(a) a first logic portion, which creates dummy parts data for unreceived parts data of a page;
(b) a second logic portion, which creates dummy page data by inserting the dummy parts data for the unreceived parts data in a position on the page allocated for the unreceived parts data; and
(c) a third logic portion, which replaces the dummy parts data when the unreceived parts data is received, with the received parts data, for creating page data for printing.

12. The system of claim 11, wherein the dummy parts data includes first information, and the third logic portion replaces the dummy parts data by referring to the first information.

13. The system of claim 12, wherein the first information includes data indicating a folder and a file in the data processing arrangement, in which the page data for printing is expected to be stored.

14. The system of claim 12, wherein the parts data when received, also includes the first information.

15. The system of claim 11, wherein the program logic further includes a layout logic portion, which creates dummy plate face data using dummy page data, and a fourth logic portion which replaces the dummy page data in the dummy plate face data when page data becomes available.

16. The system of claim 15, wherein the dummy page data includes second information, and the fourth logic portion replaces the dummy page data by referring to the second information.

17. The system of claim 16, wherein the second information includes data indicating a file and a page number in which the dummy page data is stored.

18. The device of claim 16, wherein the page data for printing, also includes the second information.

19. The system of claim 11, wherein an instruction initiates a determination in the program logic as to whether to create dummy parts data.

20. The system of claim 19, wherein if the instruction is not received, logic execution terminates.

21. A system for creating printing data during page editing and layout, the system comprising a data processing arrangement having program logic, the program logic including:
(a) a logic portion, which creates dummy parts data having link information for unreceived parts data, with the link information linking the dummy parts data with a storage location in the data processing arrangement, and inserts the dummy parts data in a position on the page allocated for the unreceived parts data; and
(b) another logic portion, which operates in background monitoring the storage location in the data processing arrangement, and when parts data is stored at the storage location, said another logic portion replaces the dummy parts data with the parts data in accordance with the link information.
